(19) United States
(12) Patent Application Publication
(10) Pub. No.: US 2011/0268929 A1
(43) Pub. Date: Nov. 3, 2011

(54) Stretch Releasable Adhesive Tape

(76) Inventors: Thu-Van T. Tran, Maplewood, MN (US); Michael D. Determan, St. Paul, MN (US); Jeffrey O. Emslander, St. Paul, MN (US); Albert I. Everaerts, Oakdale, MN (US); Jayshree Seth, Woodbury, MN (US)

(21) Appl. No.: 13/142,329

(22) PCT Filed: Dec. 3, 2009
(86) PCT No.: PCT/US2009/066503

§ 371 Date: Jun. 27, 2011

Related U.S. Application Data
(60) Provisional application No. 61/141,827, filed on Dec. 31, 2008.

(51) Int. Cl. B32B 3/00; B32B 7/12

(52) U.S. Cl. 428/189; 428/355 EN

(57) ABSTRACT

Adhesive tapes, articles containing the adhesive tapes, methods of making the adhesive tapes, and uses of the adhesive tapes are described. The adhesive tape is stretch releasable and can be used to couple two substrates together. The adhesive tape can be removed easily to separate the two substrates for any reason. The adhesive tape includes a backing layer and at least one pressure sensitive adhesive layer adjacent to the backing layer. The backing layer contains a poly(alkylene) copolymer. Each pressure sensitive adhesive layer contains an acrylic copolymer that is crosslinked plus inorganic particles that are dispersed or suspended in the acrylic copolymer.

### TECHNICAL FIELD

An adhesive tape that is stretch releasable, articles that include the adhesive tape, methods of making the adhesive tape, and uses of the adhesive tape are described.

### BACKGROUND

Stretch releasable adhesive tapes have been used to bond an article to a substrate. The article is often a hook, clamp, hanger, or caddie and the substrate is often the surface of a wall. The article can be released from the substrate by stretching the adhesive tape.

### SUMMARY

An adhesive tape that is stretch releasable, articles that contain the adhesive tape, and uses of the adhesive tape are disclosed. The adhesive tape includes a backing layer that is adjacent to at least one pressure sensitive adhesive layer. The backing layer includes a poly(alkylene) copolymer. Each pressure sensitive adhesive layer includes an acrylic copolymer that is crosslinked and inorganic particles dispersed or suspended in the acrylic copolymer. The presence of the inorganic particles in the pressure sensitive adhesive layer facilitates clean removal of the stretch releasable adhesive tape after being adhered to a substrate. The adhesive tapes can be optically clear.

In a first aspect, an adhesive tape is described. The adhesive tape includes a (A) a backing layer and (B) at least one pressure sensitive adhesive layer that is adjacent to a major surface of the backing layer. The backing layer contains a poly(alkylene) copolymer that is a first polymerized product of a first polymerizable reaction mixture that contains (1) a first alkene selected from ethene, propene, or a mixture thereof; and (2) a second alkene selected from a 1,2-alkene having 4 to 8 carbon atoms. The backing layer has a haze no greater than 5 percent and a luminous transmission equal to at least 90 percent as measured using method ASTM D1003-07. The at least one pressure sensitive adhesive layer contains (1) an acrylic copolymer and (2) inorganic particles dispersed or suspended in the acrylic copolymer in an amount up to 25 weight percent based on a total weight of acrylic copolymer. The acrylic copolymer is a crosslinked reaction product of a second polymerizable reaction mixture that includes (a) a crosslinker having at least two (meth)acryloyl groups in an amount up to 25 weight percent based on a total weight of polymerizable material in the second polymerizable reaction mixture and (b) either (i) a second monovalent monomer mixture containing 1) an alkyl(meth)acrylate having an alkyl group with at least 4 carbon atoms in an amount equal to at least 40 weight percent based on the total weight of polymerizable material in the second polymerizable reaction mixture and 2) a polar monomer in an amount up to 40 weight percent based on the total weight of polymerizable material in the second polymerizable reaction mixture or (ii) a partially polymerized product of the second monovalent monomer mixture. The adhesive tape is stretchable at least 50 percent in a first direction without breaking.

In a second aspect, an article is described. In a first embodiment, the article includes a first substrate and an adhesive tape that is adhered to the first substrate. The adhesive tape includes (A) a backing layer, (B) a first pressure sensitive adhesive layer that is adjacent to a first major surface of the backing layer, and (C) a tab that extends beyond the first substrate. Pulling the tab stretches the adhesive tape and releases the adhesive tape from the first substrate. The adhesive tape is stretchable at least 50 percent in a first direction without breaking. The backing layer contains a poly(alkylene) copolymer that is a first polymerized product of a first polymerizable reaction mixture that contains (1) a first alkene selected from ethene, propene, or a mixture thereof; and (2) a second alkene selected from a 1,2-alkene having 4 to 8 carbon atoms. The backing layer has a haze no greater than 5 percent and a luminous transmission equal to at least 90 percent as measured using method ASTM D1003-07. The first pressure sensitive adhesive layer contains (1) an acrylic copolymer and (2) inorganic particles dispersed or suspended in the acrylic copolymer in an amount up to 25 weight percent based on a total weight of acrylic copolymer. The acrylic copolymer is a crosslinked reaction product of a second polymerizable reaction mixture that includes (a) a crosslinker having at least two (meth)acryloyl groups in an amount up to 25 weight percent based on a total weight of polymerizable material in the second polymerizable reaction mixture and (b) either (i) a second monovalent monomer mixture containing 1) an alkyl(meth)acrylate having an alkyl group with at least 4 carbon atoms in an amount equal to at least 40 weight percent based on the total weight of polymerizable material in the second polymerizable reaction mixture and 2) a polar monomer in an amount up to 40 weight percent based on the total weight of polymerizable material in the second polymerizable reaction mixture or (ii) a partially polymerized product of the second monovalent monomer mixture.

In a second embodiment, the article includes a first substrate, a second substrate, and an adhesive tape that is positioned between the first substrate and the second substrate. The adhesive tape couples the first substrate to the second substrate. The adhesive tape includes a (A) a backing layer, (B) a first pressure sensitive adhesive layer that is adjacent to a first major surface of the backing layer and a second pressure sensitive adhesive layer that is adjacent to a second major surface of the backing layer, and (C) a tab that extends beyond at least one of the first substrate and the second substrate. Pulling the tab stretches the adhesive tape and releases the adhesive tape from the first substrate, from the second substrate, or from both the first substrate and the second substrate. The adhesive tape is stretchable at least 50 percent in a first direction without breaking when the tab is pulled. The backing layer contains a poly(alkylene) copolymer that is a polymerized product of a first polymerizable reaction mixture that includes (1) a first alkene selected from ethene, propene, or a mixture thereof; and (2) a second alkene selected from a 1,2-alkene having 4 to 8 carbon atoms. The backing layer has a haze no greater than 5 percent and a luminous transmission equal to at least 90 percent as measured using method ASTM D1003-07. The first pressure sensitive adhesive layer and the second pressure sensitive adhesive layer each contains an acrylic copolymer and inorganic particles dispersed or suspended in the acrylic copolymer in an amount up to 25 weight percent based on the total weight of acrylic copolymer. The acrylic copolymer is the crosslinked reaction product of a second polymerizable reaction mixture that includes (a) a crosslinker having at least two (meth)acryloyl groups in an amount up to 25 weight percent based on a total weight of polymerizable material in the second polymerizable reaction mixture and (b) either (i) a second monovalent monomer mixture containing 1) an alkyl(meth)acrylate having an alkyl group with at least 4 carbon atoms in an amount equal to at least 40 weight percent based on the total weight of polymerizable material in the second polymerizable reaction mixture and 2) a polar monomer in an amount up to 40 weight percent based on the total weight of polymerizable material in the second polymerizable reaction mixture or (ii) a partially polymerized product of the second monovalent monomer mixture.

In a third aspect, a method of coupling and decoupling two substrates is provided. The method includes providing a first substrate and a second substrate. The method further includes positioning an adhesive tape between the first substrate and the second substrate such that the adhesive tape couples the first substrate to the second substrate. The adhesive tape includes (A) a backing layer, (B) a first pressure sensitive adhesive layer that is adjacent to a first major surface of the backing layer and a second pressure sensitive adhesive layer that is adjacent to a second major surface of the backing layer, and (C) a tab that extends beyond at least one of the first substrate and the second substrate. The adhesive tape is stretchable at least 50 percent in a first direction without breaking. The backing layer contains a poly(alkylene) copolymer that is a first polymerized product of a first polymerizable reaction mixture that contains (1) a first alkene selected from ethene, propene, or a mixture thereof and (2) a second alkene selected from a 1,2-alkene having 4 to 8 carbon atoms. The backing layer has a haze no greater than 5 percent and a luminous transmission equal to at least 90 percent as measured using method ASTM D1003-07. The first pressure sensitive adhesive layer and the second pressure sensitive adhesive layer each contain (1) an acrylic copolymer and (2) inorganic particles dispersed or suspended in the acrylic copolymer in an amount up to 25 weight percent based on a total weight of acrylic copolymer. The acrylic copolymer is a crosslinked reaction product of a second polymerizable reaction mixture that includes (a) a crosslinker having at least two (meth)acryloyl groups in an amount up to 25 weight percent based on a total weight of polymerizable material in the second polymerizable reaction mixture and (b) either (i) a second monovalent monomer mixture containing 1) an alkyl(meth)acrylate having an alkyl group with at least 4 carbon atoms in an amount equal to at least 40 weight percent based on the total weight of polymerizable material in the second polymerizable reaction mixture and 2) a polar monomer in an amount up to 40 weight percent based on the total weight of polymerizable material in the second polymerizable reaction mixture or (ii) a partially polymerized product of the second monovalent monomer mixture. The method further includes pulling on the tab of the adhesive tape to release the adhesive tape from the first substrate, from the second substrate, or from both the first substrate and the second substrate.

In a fourth aspect, a method of preparing an adhesive tape is provided. The method includes providing a providing a poly(alkylene) copolymer that is the polymerized product of a first polymerizable mixture that includes (1) a first alkene selected from ethene, propene, or a mixture thereof and (2) a second alkene selected from a 1,2-alkene having 4 to 8 carbon atoms. The method further includes casting a backing layer comprising the poly(alkylene) copolymer between a first support layer and a second support layer such that the backing layer has a haze no greater than 5 percent and a luminous transmission that is at least 90 percent based on ASTM D1003-07. The method yet further includes positioning at least one pressure sensitive adhesive layer adjacent to a first major surface of the backing layer. The at least one pressure sensitive adhesive layer contains (1) an acrylic copolymer and (2) inorganic particles dispersed or suspended in the acrylic copolymer in an amount up to 25 weight percent based on a total weight of acrylic copolymer. The acrylic copolymer is a crosslinked reaction product of a second polymerizable reaction mixture that includes (a) a crosslinker having at least two (meth)acryloyl groups in an amount up to 25 weight percent based on a total weight of polymerizable material in the second polymerizable reaction mixture and (b) either (i) a second monovalent monomer mixture containing 1) an alkyl(meth)acrylate having an alkyl group with at least 4 carbon atoms in an amount equal to at least 40 weight percent based on the total weight of polymerizable material in the second polymerizable reaction mixture and 2) a polar monomer in an amount up to 40 weight percent based on the total weight of polymerizable material in the second polymerizable reaction mixture or (ii) a partially polymerized product of the second monovalent monomer mixture.

The above summary of the present invention is not intended to describe each embodiment or every implementation of the present invention. The Figures, Detailed Description, and Examples that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a schematic diagram of an exemplary stretch releasable adhesive tape.

FIG. 2 is a schematic diagram of an exemplary article that includes two substrates coupled together using the stretch releasable adhesive tape exemplified in FIG. 1.

FIG. 3 is a schematic diagram of another exemplary stretch releasable adhesive tape.

FIG. 4 is a schematic diagram of another exemplary article that includes two substrates coupled together using the stretch releasable adhesive tape exemplified in FIG. 3.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE INVENTION

Adhesive tapes, articles containing the adhesive tapes, methods of making the adhesive tapes, and uses of the adhesive tapes are described. More particularly, the adhesive tapes include at least one pressure sensitive adhesive layer that contains an acrylic copolymer that is crosslinked and inorganic particles dispersed or suspended in the acrylic copolymer. The adhesive tape can be removed by stretching after being adhered to a substrate. When pulled, the adhesive tape can be stretched at least 50 percent in a first direction without breaking. For example, the length can be increased at least 50 percent without breaking.

Although various stretch releasing adhesive layers and adhesive tapes are known, there have been problems with the use of acrylic-based adhesive layers. Often, the adhesive strength of acrylic-based adhesive layers builds over time and removal of the adhesive can be difficult. Removal of the acrylic-based adhesive often results in damage to the substrate to which it was adhered. If the adhesive can be removed, an adhesive residue is often left on the substrate. Surprisingly, the acrylic-based adhesives described herein usually can be removed relatively easily and tend to leave little or no residue on the substrates upon removal. Prior to removal by stretching, the adhesives typically exhibit high load shear adhesion.

As used herein, the term “adhesive” and “pressure-sensitive adhesive” are used interchangeably. Likewise, the terms “adhesive layer” and “pressure-sensitive adhesive layer” are used interchangeably. The terms “pressure-sensitive adhesive” and “PSA” are used interchangeably.

As used herein, the term “polymerizable material” refers to compounds of any molecular weight that has at least one polymerizable group such as an ethylenically unsaturated group. The polymerizable material can include monomers, crosslinkers, oligomers, and the like. The process of polymerization results in the formation of a polymer and includes reactions that extend a polymeric chain, that crosslink one or more polymeric chains, or both. The term “copolymer” is used to refer to a polymeric material prepared from at least two different monomers.

As used herein, the term “in the range of” includes the endpoints and all values between the endpoints.

The stretch releasable adhesive tape includes a backing layer and at least one pressure sensitive adhesive layer adjacent to the backing layer. In some embodiments, the stretch releasable adhesive tape includes a single pressure sensitive adhesive layer positioned adjacent to a first major surface of the backing layer. Such a stretch releasable adhesive tape can be placed on the outer surface of a substrate for any desired purpose. For example, the adhesive tape can provide a protective function and can be removed later if the protection is no longer needed or desired. In other examples, the adhesive tape can provide a writable or printable surface (e.g., the writing or printing can be on the backing layer). In some more specific examples, the adhesive tape can function as a label or price sticker that can be removed when no longer needed.

In other embodiments, the adhesive tape includes two pressure sensitive adhesive layers that are positioned adjacent to opposite major surfaces of the backing layer. Such a stretch releasable adhesive tape can be used to couple a first substrate to a second substrate. If at any later time it is desirable to separate the first substrate from the second substrate, the adhesive tape can be stretched for removal (e.g., stretched to release the adhesive tape from the first substrate, from the second substrate, or from both the first and second substrates). After separation from the adhesive tape and each other, the substrates can be used again. This is particularly advantageous when at least one of the substrates is expensive, fragile, or difficult to manufacture.

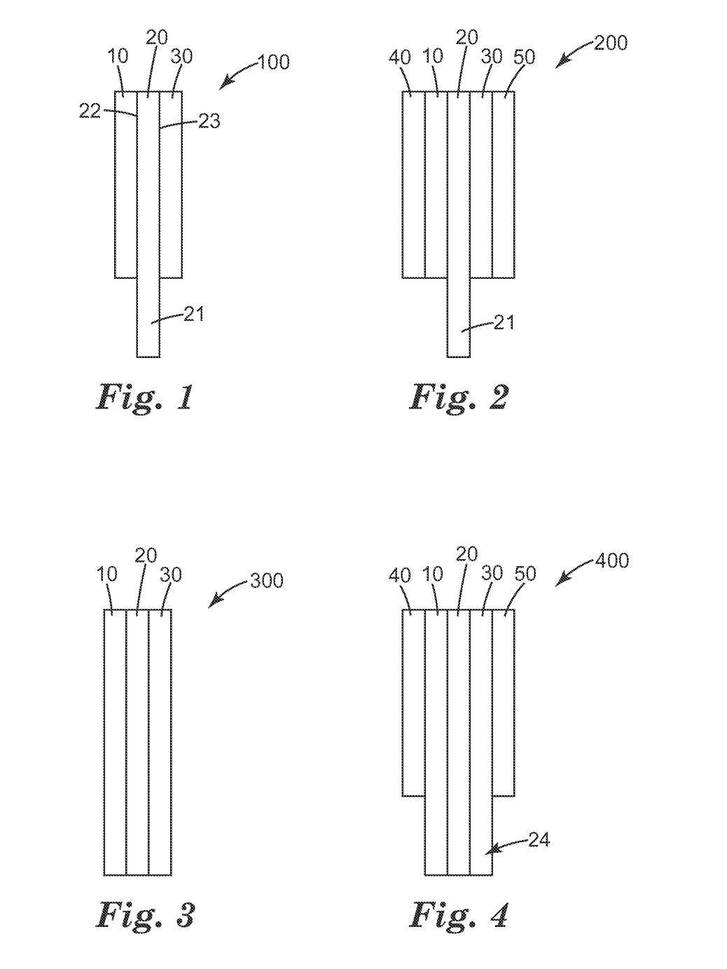

An exemplary stretch releasable adhesive tape construction with two pressure sensitive adhesive layers is shown schematically in FIG. 1. The adhesive tape 100 includes a backing layer 20 that is positioned between two pressure sensitive adhesive layers 10 and 30. The first adhesive layer 10 is adjacent to a first major surface 22 of the backing layer 20 and the second adhesive layer 30 is adjacent to the second major surface 23 of the backing layer 20. The first major surface 22 of the backing layer 20 is opposite the second major surface 23 of the backing layer 20. As shown in FIG. 1, the first adhesive layer 10 and the second adhesive layer 30 both contact the backing layer 20 and are directly adhered to the backing layer 20. In other embodiments that are not illustrated, the first adhesive layer 10 and the second adhesive layer 30 are indirectly adhered to the backing layer 20 through one or more intervening layers such as a primer layer. The backing layer 20 extends beyond both the first adhesive layer 10 and the second adhesive layer 30. The region of the backing layer 21 that extends beyond the adhesive layers can function as a tab 21. In FIG. 1, the tab 21 is a part of the backing layer or an extension of the backing layer.

FIG. 2 is exemplary schematic diagram of an article 200 that include two substrates coupled using the stretch releasable adhesive tape shown schematically in FIG. 1. The stretch releasable adhesive tape is positioned between a first substrate 40 and a second substrate 50. That is, the article 200 includes in the following order a first substrate 40, a first adhesive layer 10, a backing layer 20, a second adhesive layer 30, and a second substrate 50. The first adhesive layer 10 adheres to the first substrate 40 and the second adhesive layer 30 adheres to the second substrate 50. The pressure sensitive adhesive layer typically can be adhered to a substrate with no more than finger pressure and can remain adhered to the substrate until the adhesive tape is stretched for removal. The first substrate 40 is coupled to the second substrate 50 through the adhesive tape.

In FIG. 2, the backing layer 20 extends beyond both the first adhesive layer 10 and the second adhesive layer 30. The region of the backing layer that extends beyond both the first adhesive layer 10 and the second adhesive layer 30 can function as a tab 21 for stretch releasing the adhesive tape from both substrates 40 and 50. By pulling on the tab 21 and stretching the adhesive tape, the first adhesive layer 10 can be released from the first substrate 40, the second adhesive layer 30 can be released from the second substrate 50, or both adhesive layers 10 and 30 can be released from both substrates 40 and 50. The combined release allows the separation of the first substrate from the second substrate and the removal of the adhesive tape from between the first substrate and the second substrate.

Another stretch releasable adhesive tape 300 is shown schematically in FIG. 3 that includes a backing layer 20 plus two pressure-sensitive adhesive layers 10 and 30. In this embodiment, the backing layer 20 does not extend beyond both the first adhesive layer 10 and the second adhesive layer 30. The use of this adhesive tape to couple a first substrate 40 and a second substrate 50 is shown schematically in FIG. 4. A region of the adhesive tape (layers 10, 20, and 30) extends beyond both substrates 40 and 50. The region of the adhesive tape that extends beyond both substrates 40 and 50 can function as the tab 24. The tab 24 is tacky because the outer surfaces are the adhesive layers 10 and 30. Alternatively, an additional layer (not shown in FIG. 3) such as a film or another non-tacky layer such as talc or ink (printed) can be placed over the adhesive layers 10 and 30 in the region of the tab to provide a non-tacky surface. By pulling on the tab 24 and stretching the adhesive tape, the first adhesive layer 10 can be released from the first substrate 40, the second adhesive layer 30 can be released from the second substrate 50, or both adhesive layers 10 and 30 can be released from both substrates 40 and 50. The combined release allows the separation of the first substrate from the second substrate and the removal of the adhesive tape (layers 10, 20, and 30) between the first substrate 40 and the second substrate 50.

With an adhesive tape, releasing the adhesive from one or both substrates includes pulling on a tab and stretching. The tab extends beyond at least one of the substrates. The tab can a part of the backing layer (i.e., an extension of the backing layer), a part of at least one adhesive layer (i.e., an extension of the adhesive layer), attached to the backing layer, attached to at least one adhesive layer, or a part of both the backing layer and at least one adhesive layer (i.e., an extension of both the backing layer and at least one adhesive layer). At least one substrate does not contact the adhesive layer in the region of the tab. Usually, if there are two substrates in the article, both substrates do not contact the adhesive layer in the region of the tab. The tab is usually pulled in a direction that is parallel to or substantially parallel to the surfaces of the substrates. That is, the tab is pulled in a direction that is 0 degrees, less than 5 degrees, less than 10 degrees, less than 15 degrees, less than 20 degrees, less than 25 degrees, less than 30 degrees, or less than 35 degrees. The tab often includes a part of the backing layer. In some embodiments, the tab is formed from a second region of the backing layer that extends beyond a first region of the backing layer that is in contact with the adhesive layers. The tab is often non-tacky in these embodiments. In other embodiments, the tab includes the backing layer and at least one of the adhesive layers. The tab is often tacky in these embodiments. A tacky tab can be made non-tacky by covering the tab region with a non-tacky material.

The adhesive layers as well as backing layer of the adhesive tape are typically highly extensible. Pulling on the tab causes the adhesive tape to elongate or stretch. Stretching reduces the volume of the adhesive tape in the region between the first substrate and the second substrate and facilitates release of the adhesive tape from one or both substrates. Pulling on the tab can release the adhesive layers from both substrates if the adhesive layers have sufficient cohesive strength, if the adhesive layers adhere more strongly to the backing layer than to the substrates, and if the adhesive tape can be elongated sufficiently to reduce its volume between the substrates without breaking or snapping back into its original position. The stretched adhesive tape can be removed from between the two substrates, the two substrates can be separated, or both. The adhesive tape typically can be stretched at least 50 percent in a first direction (often the first direction is lengthwise and the length can be increased at least 50 percent) without breaking or snapping under the stretch releasing conditions.

The backing layers, the adhesive layers, and the stretch releasable adhesive tape shown schematically in FIG. 1 and FIG. 3 can be optically clear. As used herein, the term “optically clear” refers to a backing layer, an adhesive layer, or an adhesive tape that has a luminous transmission of at least 90 percent and a haze no greater than 5 percent as measured using the method ASTM D1003-07. With this method, measurements are made in the 400 to 700 nanometer wavelength range. The luminous transmission is often equal to at least 91 percent, at least 92 percent, at least 93 percent, at least 94 percent, or least 95 percent. The haze is often no greater than 4, no greater than 3, no greater than 2, or no greater than 1. Some exemplary adhesive tapes have a haze no greater than 3 percent and a luminous transmission equal to at least 90 percent as measured using method ASTM D1003-07. Other exemplary adhesive tapes have a haze no greater than 2 percent and a luminous transmission equal to at least 90 percent as measured using method ASTM D1003-07. Not all materials that are visibly clear are considered to be optically clear. That is, visible clarity is not always synonymous with optical clarity. A material that is visibly clear can have a haze value greater than 5, a luminous transmission value less than 90 percent, or both.

In some articles, the stretch releasable adhesive tape is optically clear. The optically clear adhesive tape can be positioned between two substrates such that the second substrate is visible when viewed through both the first substrate and the optically clear adhesive tape. If the adhesive tape is optically clear, the second substrate 50 in FIGS. 2 and 3 often can be viewed by looking through the first substrate 40 and the adhesive tape (as shown, the adhesive tape corresponds to layers 10, 20, and 30). For example, the optically clear adhesive tape can be used to couple a first substrate such as an optically clear substrate (e.g., a cover lens) to a second substrate such as a display (e.g., a liquid crystal display). If the coupling is not defective, the optically clear adhesive tape remains positioned between the first substrate and the display. If the coupling is defective, however, the adhesive tape can be removed without damaging the display by stretching. The adhesive tape can be replaced and the first substrate and the display can be coupled again with another optically clear, stretch releasable adhesive tape.

In addition to being optically clear, the backing layer is selected to have suitable mechanical properties for use in a stretch release adhesive tape. For example, the backing layer is selected so that it can be stretched (elongated) when pulled in a first direction (e.g., a lengthwise direction) at least 50 percent without breaking. That is, at least one dimension such as the length can be increased at least 50 percent through stretching without breaking the backing layer. In some embodiments, the backing layer can be stretched at least 100 percent, at least 150 percent, at least 200 percent, at least 300 percent, at least 400 percent, or at least 500 percent without breaking. The backing layer can often be stretched up to 1200 percent, up to 1000 percent, up to 800 percent, up to 750 percent, or up to 700 percent without breaking. These relatively large elongation values facilitate stretch releasing of the adhesive tape after being adhered to a substrate.

The Young's Modulus of the backing layer can be an indicator of the resistance of the backing layer to stretching. The Young's Modulus is often in the range of about 10 MPa to about 75 MPa. For example, the Young's Modulus can be in the range of 20 to 75 MPa, in the range of 20 to 60 MPa, in the range of 20 to 50 MPa, or in the range of 25 to 50 MPa. The Young's Modulus can be measured, for example, using method ASTM D790-07 or ASTM D882-02.

The tensile strength of the backing layer is an indicator of the load that the backing layer can sustain without breaking and is an indicator of how far the backing layer can be stretched without breaking. The tensile strength is typically in the range of about 10 MPa to about 60 MPa or higher. For example, the tensile strength can be in the range of 10 to 60 MPa, in the range of 10 to 50 MPa, in the range of 20 to 60 MPa, in the range of 20 to 55 mPa, or in the range of 25 to 50 MPa. The tensile strength can be measured using method ASTM D882-02.

The backing layer 20 contains a poly(alkylene) copolymer that is derived from at least two different alkene monomers. The poly(alkylene) copolymer is a first polymerized product a first polymerizable mixture that includes (1) a first alkene selected from ethene, propene, or a mixture thereof and (2) a second alkene selected from a 1,2-alkene having 4 to 8 carbon atoms. In many poly(alkylene) copolymers, the 1,2-alkene is selected from butene, hexene, or octane. These copolymers are typically prepared using a metallocene catalyst.

Not all poly(alkylene) copolymers are suitable for preparation of the backing layer. That is, not all known poly(alkylene) copolymers can be used to provide a backing layer having the combination of suitable mechanical and optical properties. Many poly(alkylene) copolymers with suitable mechanical properties do not have low haze (i.e., no greater than 5 percent as measured using method ASTM D1003-07) and high luminous transmission (i.e., at least 90 luminous transmission as measured using ASTM D1003-07) that is usually needed to prepare an optically clear backing layer. Optically clear backing layers are needed to prepare an optically clear adhesive tape. For example, the relatively large crystalline size of many poly(alkylene) copolymers, the use of various additives in many commercially available poly(alkylene) copolymers, and the specific methods used to form films of the poly(alkylene) copolymer can make then unsuitable for use as the backing layer.

The poly(alkylene) copolymer in the backing layer preferably has some crystalline material rather than being completely amorphous. The crystalline material tends to add strength to the backing layer by functioning as a physical crosslinker. If the size of the crystalline material is too large, however, the haze of the backing layer can be unacceptably large. The crystalline material preferably has a size that is less than a wavelength of visible light. In many embodiments of suitable poly(alkylene) copolymers, at least 95 percent of the crystalline material has a crystalline size less than 400 nanometers. For example, at least 95 percent of the crystalline material can have a crystalline size less than 300 nanometers, less than 200 nanometers, or less than 100 nanometers. A small crystalline size facilitates the formation of a backing layer that is optically clear.

Backing layers with crystalline material smaller than 400 nanometers can be prepared using various methods. In one method, the poly(alkylene) copolymers used to form the backing layer are melted, extruded, and quenched rapidly so that the alignment and growth of the crystals is minimized. In another method, seed materials (i.e., nucleating agents) can be added that facilitate the formation of many crystals within the copolymer upon cooling to form the solidified film. The formation of more crystals tends to favor smaller crystalline sizes. In yet another method, the copolymer composition is varied to alter the crystalline size. A greater amount of the second alkene monomer having 4 to 8 carbon atoms tends to result in smaller crystalline size. The density or specific gravity tends to decrease as the amount of the second alkene monomer increases. The specific gravity is often no greater than 0.91. For example, the specific gravity is often no greater than 0.90 or no greater than 0.89. The specific gravity is often in the range of 0.86 to 0.91, in the range of 0.87 to 0.90, or in the range of 0.88 to 0.90.

The backing layer preferably is free or substantially free of additives that contribute haze or that lower the luminous transmission. For example, the backing layer typically does not include an anti-blocking agent, a slip agent, or both. That is, the backing layer is usually free or substantially free of an anti-blocking agent, slip agent, or both. As used herein, the term “substantially free” with reference to the anti-blocking agent or to the slip agent means that these agents are each present in an amount no greater than 0.5 weight percent, no greater than 0.3 weight percent, no greater than 0.2 weight percent, no greater than 0.1 weight percent, no greater than 0.05 weight percent, or no greater than 0.01 weight percent. Anti-blocking agents are often added when films are prepared from poly(alkylene) copolymers to prevent the film from sticking to itself such as when formed into a roll. Exemplary anti-blocking agents include, but are not limited to, particles such as diatomaceous earth and talc. Slip agents are often added to reduce friction such as film-to-film friction in a roll or film-to-production equipment friction. The presence of these slip agents also can interfere with good adhesion to the at least one pressure sensitive adhesive layer. Many commonly used slip agents are primary amides such as those made from long chain fatty acids by amidation. Examples of slip agents include, but are not limited to, stearamide, oleamide, and erucamide.

In many embodiments, the backing layer contains at least 99 percent poly(alkylene) copolymer. For example, the backing layer contains at least 99.1 weight percent, at least 99.2 weight percent, at least 99.3 weight percent, at least 99.4 weight percent, at least 99.5 weight percent, at least 99.6 weight percent, at least 99.7 weight percent, at least 99.8 weight percent, at least 99.9 weight percent poly(alkylene) copolymer.

Exemplary poly(alkylene) copolymers that can be used to prepare optically clear backing layers are commercially available under the trade designation EXACT (e.g., EXACT 3024, 3040, 4011, 4151, 5181, and 8210) and VISTAMAXX (e.g., VISTAMAXX 6202 and 3000) from ExxonMobile Chemical (Houston, Tex.). Other exemplary poly(alkylene) copolymers are commercially available under the trade designations AFFINITY (e.g., AFFINITY PT 1845G, PL 1845G, PF 1140G, PL 1850G, and PL 1880G), ENGAGE (e.g., ENGAGE 8003), and INFUSE (e.g., INFUSE D9530.05) from Dow Chemical (Midland, Mich.). EXACT 8210, EXACT 5181, ENGAGE 8003, and INFUSE D9530.05 are ethylene-octene copolymers. EXACT 3040 and EXACT 4151 are ethylene-hexene copolymers. EXACT 3024 and EXACT 4011 are ethylene-butene copolymers.

In addition to choosing suitable materials that will result in backing layers with low haze and high luminous transmission, the method of preparing the backing layer if often selected to maintain these values. That is, the method of making the backing layer is typically selected to provide a smooth surface and a relatively uniform thickness. If the surface is roughened, the percent haze may become undesirably large. To provide suitable optical clarity, a process is used to provide a thickness that is relatively uniform across the backing layer in any direction. For example, thickness often varies by less than 10 percent, less than 8 percent, less than 6 percent, less than 5 percent across the backing layer in any direction. More specifically, a backing layer having an average thickness of 4 mils (0.1 millimeter or 100 micrometers) has a thickness variation of less than 10 micrometers, less than 8 micrometers, less than 6 micrometers, or less than 5 micrometers across the backing layer in any direction.

Many conventional methods used to form films of poly(alkylene) copolymers are not suitable because the resulting films do not have the requisite smoothness. For example, blowing methods are usually not suitable because anti-blocking agents or slip agents are typically added. The addition of these agents often tends to roughen the surface of the resulting film. Cast extrusion methods that impart a rough surface to the film in an attempt to minimize contact with a chill roller are typically not suitable.

Various methods can be used to prepare backing layers with suitable smoothness and thickness uniformity. In a first example, the poly(alkylene) copolymers can be cast between two smooth support layers such as release liners or between a smooth support layer and a smooth roller. No blocking agent or slip agent is needed and the absence of these agents is preferred. The support layers (e.g., release liners) tend to reinforce the resulting rubbery backing layer and allow the backing layer to be subjected to further processing without distortion or stretching. Further, the support layers tend to protect the surface until it is combined with the at least one pressure sensitive adhesive layer.

More specifically, the poly(alkylene) copolymer can be extruded as a molten film using, for example, a flat cast extrusion die. The extrusion temperature can be in the range of about 150° C. to 200° C. The extruded film of poly(alkylene) copolymer can be extruded between two support films. The resulting construction of support film/poly(alkylene) copolymer film/support film can then be passed through a chilled roll stack to cool and solidify the poly(alkylene) copolymer film. Backing films that are prepared using this method tend to have a relatively uniform thickness and to be relatively smooth.

Any suitable support surface can be used for forming the backing layer. In many embodiments, the support is a release liner. Any suitable release liner can be used. Suitable release liners are typically paper (e.g., Kraft paper) or polymeric films. In many applications, polymeric films are preferred. Polymeric films used as release liners can be formed, for example, from polyester such as polyethylene terephthalate or polyolefins such as polyethylene, polypropylene, or combinations thereof. The surface of the release liners can be optionally treated with a release agent such as a silicone, a fluorochemical such as a fluorosilicone, or other low surface energy materials such as a polyolefin (e.g., polyethylene, polypropylene, or low density polyethylene). An exemplary fluorosilicone is commercially available from Dow Corning under the trade designation SYL-OFF (e.g., SYL-OFF Q2-7785 or SYL-OFF Q2-7786). Other release liners include, for example, are commercially available under the trade designation CLEARSIL T10 and CLEARSIL T50 from CPI Films (St. Louis, Mo.). Suitable release liners and methods for treating liners are further described in, for example, U.S. Pat. Nos. 4,472,480 (Olson), 4,980,443 (Kendziorski), and 4,736,048 (Brown et al.), 5,578,381 (Hamada et al.), and 5,082,706 (Tangney); and U.S. Patent Application Publication 2008/0280086 (Sheridan et al.).

The thickness of the backing layer is often selected based on the desired stretch release force. A greater stretch release force is usually needed as the thickness of the backing layer is increased. Conversely, a lower stretch release forces is needed as the thickness of the backing layer is decreased. The thickness of the backing layer can be, for example, up to 40 mils (1.0 millimeter or 1000 micrometers). As used herein, the term “mil” refers to 0.001 inch and 1 mil is equal to about 0.0025 centimeters or about 0.025 millimeters or about 25 micrometers. In many embodiments, the thickness is up to 30 mils (750 micrometers), up to 20 mils (500 micrometers), up to 10 mils (250 micrometers), up to 8 mils (200 micrometers), up to 6 mils (150 micrometers), or up to 5 mils (125 micrometers). The thickness is often at least 1 mil (0.025 millimeters or 25 micrometers), at least 2 mils (50 micrometers), at least 3 mils (75 micrometers), or at least 4 mils (100 micrometers). Some suitable backing layers have a thickness in the range of 1 mil (25 micrometers) to 20 mils (500 micrometers), in the range of 1 mil (25 micrometers) to 10 mils (250 micrometers), in the range of 1 mil (25 micrometers) to 8 mils (200 micrometers), in the range of 1 mil (25 micrometers) to 7 mils (175 micrometers) in the range of 2 mils (50 micrometers) to 8 mils (200 micrometers), in the range of 3 mils (75 micrometers) to 6 mils (150 micrometers), or in the range of 4 mils (100 micrometers) to 5 mils (125 micrometers).

As prepared, the backing layer is usually a rubbery material with smooth surface. In many embodiments, the backing layer is slightly tacky. A pressure sensitive adhesive layer can be positioned adjacent to at least one major surface of the backing layer. In many embodiments, a first pressure sensitive adhesive layer is positioned adjacent to a first major surface of the backing layer and a second pressure sensitive adhesive layer is positioned adjacent to a second major surface of the backing layer. The second major surface of the backing layer is the surface opposite the first major surface. As used herein, the term “adjacent” with reference to the pressure sensitive adhesive layer and the backing layer means that the pressure sensitive adhesive layer contacts the backing layer or is separated from the backing layer by one or more intervening layers. That is, each pressure sensitive adhesive layer is adhered directly or indirectly to the backing layer.

The backing layer can be subjected to a priming treatment prior to being positioned adjacent to the at least one pressure-sensitive adhesive layer. The primer treatment tends to increase adhesion between the backing layer and the pressure-sensitive adhesive layer. This increased adhesion is often desirable for a stretch releasing adhesive tape. That is, it is usually desirable that the adhesion of the pressure-sensitive adhesive layer to the backing layer is stronger than the adhesion of the pressure-sensitive adhesive layer to the substrate. Any suitable priming treatment known in the art can be used. For example, the priming treatment can include treatment with a chemical primer composition, treatment with a corona discharge or plasma discharge, exposure to an electron beam or ultraviolet light, etching with an acidic composition, or combinations thereof.

In some embodiments, the primer treatment includes applying a primer composition to a surface of the backing layer. Any suitable primer composition can be used. The primer composition can include, for example, a reactive chemical adhesive promoter (e.g., the components can react with the backing layer, the adhesive layer, or both). Exemplary primer compositions include those described in U.S. Pat. No. 5,677,376 (Groves), incorporated herein by reference in its entirety. That is, the primer composition can include a blend of (1) a block copolymer such as styrene-ethylene/butylene-styrene block copolymer that is modified with maleic acid or maleic anhydride and (2) the polymeric reaction product of monovalent monomer mixture that includes (a) at least one alkyl(meth)acrylate ester of a non-tertiary alcohol having 1 to 14 carbon atoms and (b) at least one nitrogen-containing monomer. The block copolymer can be, for example, those commercially available from Shell Chemical Co. under the trade designation KRATON FG-1901X. Other suitable primer compositions include those commercially available under the trade designation NEOREX (NEOREX R551) from (Wilmington, Mass.). This primer composition contains waterborne polyurethane.

Each pressure sensitive adhesive layer of the adhesive tape includes an acrylic copolymer and inorganic particles dispersed or suspended in the acrylic copolymer. In many embodiments, the acrylic copolymer is a random copolymer. The acrylic copolymer is usually formulated to exhibit the requisite viscoelastic properties resulting in a desired balance of tack, peel adhesion, and shear holding power. That is, the monomers used to prepare the acrylic copolymer are chosen to satisfy the Dahlquist criterion (i.e., the rubbery plateau modulus is lower than the Dahlquist number). Stated differently, the acrylic copolymer itself is often a pressure sensitive adhesive without the addition of a tackifier.

The at least one pressure sensitive adhesive layer is formed from a second precursor composition that contains a second polymerizable reaction mixture and inorganic particles. The acrylic copolymer is formed from the second polymerizable reaction mixture. That is, the acrylic copolymer is the crosslinked reaction product of the second polymerizable mixture. The second polymerizable reaction mixture includes (a) a crosslinker having at least two (meth)acryloyl groups and (b) either (i) a second monovalent monomer mixture that contains 1) an alkyl(meth)acrylate with an alkyl group having at least 4 carbon atoms and 2) a polar monovalent monomer or (ii) a partially polymerized product of the second monovalent monomer mixture.

More specifically, the second polymerizable reaction mixture includes (a) a crosslinker having at least two (meth)acryloyl groups in an amount up to 25 weight percent based on a total weight of polymerizable material in the second polymerizable reaction mixture and (b) either (i) a second monovalent monomer mixture containing 1) an alkyl(meth)acrylate with an alkyl group having at least 4 carbon atoms in an amount equal to at least 40 weight percent based on the total weight of polymerizable material in the second polymerizable reaction mixture and 2) a polar monovalent monomer in an amount up to 40 weight percent based on the total weight of polymerizable material in the second polymerizable reaction mixture or (ii) a partially polymerized product of the second monovalent monomer mixture. Inorganic particles are present in an amount up to 25 weight percent based on the weight of the polymerizable material in the second polymerizable reaction mixture or based on the weight of the acrylic copolymer, which is the polymerized product of the second polymerizable reaction mixture.

The second polymerizable reaction mixture includes a crosslinker with at least two (meth)acryloyl groups. As used herein, the term “(meth)acryloyl” refers to an acryloyl group, a methacryloyl group, or both. Likewise, the term “(meth)acrylate” refers to an acrylate, a methacrylate, or both; the term “(meth)acrylamide” refers to an acrylamide, a methacrylamide, or both; and the term “(meth)acrylic acid” refers to acrylic acid, methacrylic acid, or both. The crosslinkers can be di(meth)acrylates, tri(meth)acrylates, tetra(meth)acrylates, penta(meth)acrylates, and the like. These crosslinkers can be formed, for example, by reacting (meth)acrylic acid with a polyhydric alcohol (i.e., an alcohol having at least two hydroxyl groups). The polyhydric alcohol often has two, three, four, or five hydroxyl groups. Mixtures of crosslinkers can be used. The molecular weight of the crosslinker is often less than about 500 grams/mole.

In many embodiments, the crosslinker contains at least two acryloyl groups. Exemplary crosslinkers with two acryloyl groups include 1,2-ethanediol diacrylate, 1,3-propanediol diacrylate, 1,9-nonane diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, and neopentylglycol hydroxypivalate diacrylate modified caprolactone. Exemplary crosslinkers with three or four (meth)acryloyl groups include, but are not limited to, trimethylolpropane triacrylate (e.g., commercially available under the trade designation TMPTA-N from Surface Specialties, Smyrna, Ga. and under the trade designation SR-351 from Sartomer, Exton, Pa.), pentaerythritol triacrylate (e.g., commercially available under the trade designation SR-444 from Sartomer), tris(2-hydroxyethylisocyanurate) triacrylate (commercially available under the trade designation SR-368 from Sartomer), a mixture of pentaerythritol triacrylate and pentaerythritol tetraacrylate (e.g., commercially available from Surface Specialties under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), di-trimethylolpropane tetraacrylate (e.g., commercially available under the trade designation SR-355 from Sartomer), and ethoxylated pentaerythritol tetraacrylate (e.g., commercially available under the trade designation SR-494 from Sartomer). An exemplary crosslinker with five (meth)acryloyl groups includes, but is not limited to, dipentaerythritol pentaacrylate (e.g., commercially available under the trade designation SR-399 from Sartomer).

The crosslinker is typically added for cohesive reinforcement of the pressure sensitive adhesive layer. An adhesive layer with good cohesive strength is less likely to leave a residue when the adhesive tape is stretched for removal after being adhered to the substrate. If too much crosslinker is added, however, the adhesive layer tends to become less compliant and may not function as a pressure sensitive adhesive. The amount of the crosslinker in the second polymerizable reaction mixture is often selected based on the molecular weight of the crosslinker and the number of reaction sites available for crosslinking. The crosslinker is often present in an amount up to 25 weight percent based on the total weight of polymerizable material in the second polymerizable reaction mixture. The amount of the crosslinker is often up to 20 weight percent, up to 15 weight percent, up to 10 weight percent, or up to 5 weight percent based on the total weight of the polymerizable material in the second polymerizable reaction mixture. The crosslinker can be present in an amount equal to at least 0.01 weight percent, at least 0.02 weight percent, at least 0.05 weight percent, at least 0.1 weight percent, at least 0.2 weight percent, at least 0.5 weight percent, at least 0.75 weight percent, at least 1 weight percent, or at least 2 weight percent. In some examples, the crosslinker in the second polymerizable reaction mixture is present in an amount in the range of 0.01 to 25 weight percent, in the range of 0.01 to 15 weight percent, in the range of 0.01 to 10 weight percent, in the range of 0.01 to 5 weight percent, in the range of 0.05 to 5 weight percent, in the range of 0.1 to 5 weight percent, in the range of 0.01 to 2 weight percent, in the range of 0.1 to 2 weight percent, or in the range of 0.01 to 1 weight percent based on the total weight of the polymerizable material in the second polymerizable reaction mixture.

In addition to the crosslinker, the second polymerizable reaction mixture includes either (i) a second monovalent monomer mixture or (ii) a partially polymerized product of the second monovalent monomer mixture. The second monovalent monomer mixture includes both 1) an alkyl(meth)acrylate having at least 4 carbon atoms and 2) a polar monomer. As used herein, the term “monovalent monomer” refers to a compound having only one group that is capable of undergoing a free radical polymerization reaction. Monovalent monomers typically have a single ethylenically unsaturated group. As used herein, the term “partially polymerized product” refers to a mixture that include monomers that have not been polymerized plus at least some higher molecular weight materials formed by polymerization. The monomers have not been completely polymerized.

The alkyl(meth)acrylate in the second monovalent monomer mixture is usually added to control the glass transition temperature (Tg) and the storage modulus of the acrylic copolymer. To provide a pressure sensitive adhesive layer, the Tg of the acrylic copolymer is usually less than room temperature (e.g., less than 25° C. or less than 20° C.).

The alkyl(meth)acrylate is often an alkyl acrylate. The alkyl acrylate can be the reaction product of acrylic acid with a monohydric alcohol. The alcohol is usually not a tertiary alkyl alcohol. Suitable alkyl(meth)acrylate monomers often have an alkyl group with at least 4 carbon atoms, at least 6 carbon atoms, or at least 8 carbon atoms. For example, the alkyl group of the alkyl(meth)acrylate often has 4 to 20 carbon atoms, 4 to 18 carbon atoms, 4 to 16 carbon atoms, 4 to 14 carbon atoms, 4 to 12 carbon atoms, or 4 to 10 carbon atoms. The alkyl group of the alkyl(meth)acrylate can be linear, cyclic, or a combination thereof and can be optionally substituted with an aryl group such as a phenyl. Exemplary alkyl(meth)acrylates include, but are not limited to, n-butyl acrylate, isobutyl acrylate, hexyl acrylate, 2-ethylhexyl acrylate, isooctyl acrylate, n-octyl acrylate, n-octyl methacrylate, 2-methylbutyl acrylate, isononyl acrylate, n-nonyl acrylate, isoamyl acrylate, n-decyl acrylate, isodecyl acrylate, isobornyl acrylate, 4-methyl-2-pentyl acrylate, and dodecyl acrylate. There are often more than one alkyl(meth)acrylate monomers included in the second polymerizable reaction mixture used to form the pressure sensitive adhesive layer. For example, the second polymerizable reaction mixture can contain two, three, four, or even more alkyl(meth)acrylates monomers with an alkyl group having at least 4 carbon atoms. Often, the alkyl(meth)acrylate includes isooctyl acrylate.

The alkyl(meth)acrylate monomer is often present in an amount equal to at least 40 weight percent based on the total weight of polymerizable material in the second polymerizable reaction mixture. For example, the alkyl(meth)acrylate monomer can be present in an amount equal to at least 50 weight percent, at least 60 weight percent, at least 70 weight percent, at least 75 weight percent, or at least 80 weight percent based on the weight of polymerizable material in the second polymerizable reaction mixture. The amount of the alkyl(meth)acrylate can be up to 99 weight percent, up to 95 weight percent, up to 90 weight percent, up to 85 weight percent, or up to 80 weight percent based on the weight of polymerizable material in the second polymerizable reaction mixture. In some examples, the alkyl(meth)acrylate monomer is present in an amount in the range of 40 to 99 weight percent, in the range of 50 to 99 weight percent, in the range of 50 to 95 weight percent, in the range of 60 to 95 weight percent, in the range of 60 to 90 weight percent, in the range of 70 to 95 weight percent, or in the range of 70 to 90 weight percent.

In addition to the alkyl(meth)acrylate, the second monovalent monomer mixture includes a polar monomer. As used herein, the term “polar monomer” refers to a monomer having a single ethylenically unsaturated group and a polar group. The polar group is often a hydroxyl group, a carboxyl group or a salt thereof, a secondary amido group, a tertiary amido group, or an ether group (i.e., a group containing at least one alkylene-oxy-alkylene group of formula —R—O—R— where each R is an alkylene having 1 to 4 carbon atoms). Any suitable salt can be used. In many embodiments, the cation of the salt is an ion of an alkaline metal (e.g., sodium, potassium, or lithium ion), an ion of an alkaline earth (e.g., calcium, magnesium, or strontium ion), an ammonium ion, or an ammonium ion substituted with one or more alkyl groups, an ammonium ion substituted with one or more aryl groups, or an ammonium ion substituted with one or more alkyl groups and one or more aryl groups.

The polar monomer in the second monovalent monomer mixture is usually added to enhance adhesion to the backing layer, to enhance adhesion to substrates with polar surfaces, and to increase the cohesive strength of the pressure sensitive adhesive layer. Often, the durability of the adhesive tape upon exposure to relatively high temperature, high humidity conditions, or both can be improved by the addition of the polar monomer. Exemplary polar monomers with a hydroxyl group include hydroxyalkyl(meth)acrylates (e.g., 2-hydroxyethyl acrylate or 3-hydroxypropyl acrylate), hydroxyalkyl(meth)acrylamides (e.g., 2-hydroxyethyl acrylamide or 3-hydroxypropyl acrylamide), and ethoxylated hydroxyethyl methacrylate (e.g., monomers commercially available from Sartomer under the trade designation CD570, CD571, CD572). Exemplary polar monomers with a carboxyl group include, but are not limited to, acrylic acid, methacrylic acid, and itaconic acid. Exemplary polar monomers with secondary amido groups include N-alkyl acrylamides such as N-methyl acrylamide, N-ethyl acrylamide, N-isopropyl acrylamide, or tert-octyl acrylamide. Exemplary polar monomers with a tertiary amido group include, but are not limited to, N-vinyl caprolactam, N-vinyl-2-pyrrolidone, acryloyl morpholine, vinyl pyridine, vinyl imidazole, and N,N-dialkyl acrylamides such as N,N-dimethyl acrylamide, N,N-diethyl acrylamide, N,N-dipropyl acrylamide, and N,N-dibutyl acrylamide. Exemplary polar monomers with an ether group include, but are not limited to, alkoxylated alkyl acrylates such as ethoxyethoxyethyl acrylate, 2-methoxyethyl acrylate, and 2-ethoxyethyl acrylate; and poly(alkylene oxide) acrylates such as poly(ethylene oxide) acrylates, and poly(propylene oxide) acrylates. The poly(alkylene oxide) acrylates are often referred to as poly(alkylene glycol) acrylates. These monomers can have any suitable end group such as a hydroxyl group or an alkoxy group. For example, when the end group is a methoxy group, the monomer can be referred to as methoxy poly(ethylene glycol) acrylate.

The second polar monomer can be present in an amount up to 40 weight percent based on the total weight of polymerizable material in the second polymerizable reaction mixture. In many embodiments, the second polar monomer is present in an amount up to 35 weight percent, up to 30 weight percent, up to 20 weight percent, up to 15 weight percent, or up to 10 weight percent. The second polymerizable reaction mixture often contains at least 1 weight percent, at least 2 weight percent, at least 3 weight percent, or at least 5 weight percent of the second polar monomer. The second polar monomer can be present, for example, in the range of 1 to 40 weight percent, in the range of 1 to 35 weight percent, in the range of 1 to 30 weight percent, in the range of 1 to 25 weight percent, in the range of 1 to 20 weight percent, in the range of 1 to 15 weight percent, in the range of 2 to 15 weight percent, in the range of 5 to 20 weight percent, or in the range of 5 to 15 weight percent based on a total weight of polymerizable material in the second polymerizable reaction mixture.

The amount of the polar monomer that can be included in the second monomer mixture is somewhat dependent on the particular polar monomer that is used. For example, if the polar monomer is an acidic monomer such as acrylic acid, methacrylic acid, or itaconic acid, the amount added is usually no greater than 15 weight percent, no greater than 10 weight percent, or no greater than 5 weight percent. On the other hand, polar monomer such as vinyl caprolactone, N-vinyl-2-pyrrolidone, N-alkyl acrylamides, alkoxylated alkyl acrylates, and poly(alkylene oxide) acrylates usually can be used in amount up to 40 weight percent.

The second polymerizable reaction mixture usually further includes a free radical polymerization initiator. The polymerization initiator can be a thermal initiator, a photoinitator, or both. Any suitable thermal initiator or photoinitator known for free radical polymerization reactions can be used. The initiator is typically present in an amount in the range of 0.01 to 5 weight percent, in the range of 0.01 to 2 weight percent, in the range of 0.01 to 1 weight percent, or in the range of 0.01 to 0.5 weight percent based on a total weight of polymerizable material in the second polymerizable reaction mixture.

In some embodiments, a thermal initiator is used. The thermal initiator is typically a peroxide or azo compound. Exemplary peroxides include, but are not limited to, benzoyl peroxide, cyclohexane peroxide, or lauryl peroxide. Exemplary azo compounds include, but are not limited to, 2,2′-azobis(2-methylbutane nitrile) that is commercially available under the trade designation VAZO 67 from DuPont (Wilmington, Del.), 2,2′-azobis(isobutyronitrile) that is commercially available as VAZO 64 from DuPont, and 2,2′-azobis(2,4-dimethylpentane nitrile) that is commercially available as VAZO 52 from DuPont.

In many embodiments, a photoinitiator is used. Some exemplary photoinitiators are benzoin ethers (e.g., benzoin methyl ether or benzoin isopropyl ether) or substituted benzoin ethers (e.g., anisoin methyl ether). Other exemplary photoinitiators are substituted acetophenones such as 2,2-diethoxyacetophenone or 2,2-dimethoxy-2-phenylacetophenone (commercially available under the trade designation IRGACURE 651 from Ciba Corp. (Tarrytown, N.Y.) or under the trade designation ESACURE KB-1 from Sartomer (Exton, Pa.)). Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime.

Each pressure sensitive adhesive layer contains inorganic particles suspended or dispersed in the acrylic copolymer, which is the crosslinked reaction product of the second polymerizable reaction mixture. The inorganic particles can be added to the monomer mixture prior to any partial polymerization or can be added after partial polymerization of the monomer mixture. The addition of the inorganic particles to the pressure sensitive adhesive layer tend to increase the cohesive strength of this layer and to increase the rubbery plateau modulus. Surprisingly, the addition of the inorganic particles decreases the adhesive residue remaining on the substrate when the adhesive tape is stretched for removal after having been adhered to the substrate. That is, the tackiness of the adhesive layer tends to decrease with stretching in the presence of the inorganic particles.

The inorganic particles can be uniformly or non-uniformly distributed throughout the second precursor composition. Likewise, the inorganic particles can be uniformly or non-uniformly distributed throughout the acrylic copolymer. The inorganic particles can be any suitable metal, metal oxide, or ceramic material, or mixture thereof. The inorganic particles are often selected from, but not limited to, alumina, titania, zirconia, silica, or the like.

In many embodiments, the inorganic particles are fumed silica particles. Suitable fumed silica is commercially available, for example, under the trade designation AEROSIL (e.g., AEROSIL R972, R974, R976, R300, R380, R130, R150, R200, 8202, R805, and R812) from Evonik Industries (Essen, Germany) or under the trade designation CABOSIL (e.g., CABOSIL TS-720, TS-610, TS-530, and TS-500) from Cabot (Alpharetta, Ga.). The fumed silica can have either a hydrophilic or hydrophobic surface and can have any suitable surface area. For example, the surface area can be in the range of 1 to 500 m²/gram, in the range of 10 to 400 m²/gram, or in the range of 100 to 400 m²/gram.

In other embodiments, the inorganic particles are aerogels such as silica aerogel particles (e.g., crushed aerogels or areogel powder). The silica aerogel particles often have pores in the nanometer range (e.g., less than 100 nanometers or less than 50 nanometers) and have surface areas equal to at least 500 m²/gram. Some exemplary aerogel silica particles have an average particle size that is less than 20 microns or less than 10 microns. Although the size of the silica aerogel particles are larger than the wavelength of light, the particles are often translucent and can be used to form adhesive layers that are relatively clear even though they may not be considered to be optically clear. Exemplary silica aerogel particles in translucent and opacified grades are commercially available under the trade designation NANOGEL from Cabot (Billerica, Mass.).

Although the inorganic particles can be surface modified to facilitate dispersion in the first acrylic copolymer or in the first precursor composition, the inorganic particles are often not surface modified. The inorganic particles can be agglomerated or non-agglomerated and aggregated or non-aggregated. The inorganic particles can have any desired particle size. In embodiments where the adhesive tape is optically clear, the inorganic particles tend to have an average primary particle size that is less than 1000 nanometers, less than 500 nanometers, less than 200 nanometers, less than 100 nanometers, or less than 50 nanometers. To prepare an optically clear adhesive tape, the inorganic particles are nanoparticles having an average primary particle size in the range of 1 to 200 nanometers, in the range of 1 to 100 nanometers, in the range of 1 to 75 nanometers, or in the range of 1 to 50 nanometers. Although the silica aerogel particles are larger than this, they are often translucent and often can be used to prepare visibly clear adhesive layers or slightly opaque adhesive layers. That is, although the backing layers are optically clear, they can be coupled with adhesive layers that are optically clear, visibly clear, slightly opaque, or opaque.

The pressure sensitive adhesive layer can include, for example up to 25 weight percent inorganic particles based on the total weight of polymerizable material in the second polymerizable reaction mixture or based on the weight of the acrylic copolymer. For example, the pressure sensitive adhesive layer can contain up to 20 weight percent, up to 15 weight percent, up to 10 weight percent, or up to 5 weight percent inorganic particles. The pressure sensitive adhesive layer often includes at least 1 weight percent, at least 2 weight percent, at least 5 weight percent, or at least 10 weight percent inorganic particles. For example, the amount of inorganic particles can be in the range of 1 to 25 weight percent, in the range of 1 to 20 weight percent, in the range of 2 to 20 weight percent, in the range of 1 to 15 weight percent, in the range of 1 to 10 weight percent, or in the range of 2 to 10 weight percent based on the total weight of polymerizable material in the second polymerizable reaction mixture or based on the weight of the acrylic copolymer.

Although the acrylic copolymer formed by polymerization of the second polymerizable reaction mixture is typically a pressure sensitive adhesive material, a tackifier can be added to the second precursor composition (i.e., the second precursor composition can include the second polymerizable reaction mixture, inorganic particles, and a tackifier). Any tackifier typically included in pressure sensitive adhesive compositions can be used. Either solid or liquid tackifiers can be added. Solid tackifiers generally have a number average molecular weight (Mn) no greater than about 10,000 grams/mole and a softening point above about 70° C. Liquid tackifiers are viscous materials that have a softening point of about 0° C. to about 70° C. Solid tackifying resins are generally preferred.

Suitable tackifying resins include rosins and their derivatives (e.g., rosin esters); polyterpenes and aromatic-modified polyterpene resins; coumarone-indene resins; and hydrocarbon resins such as alpha pinene-based resins, beta pinene-based resins, limonene-based resins, aliphatic hydrocarbon-based resins, aromatic-modified hydrocarbon-based resins, aromatic hydrocarbon resins, and dicyclopentadiene-based resins. These tackifying resins, if added, are often hydrogenated to lower their color contribution to the pressure sensitive adhesive layer.

If added, the tackifier is often present in an amount up to about 40 weight percent based on the total weight of polymerizable material in the second polymerizable reaction mixture. The tackifier can be present, for example, in an amount up to 35 weight percent, up to 30 weight percent, up to 25 weight percent, up to 20 weight percent, up to 15 weight percent, or up to 10 weight percent. Some second precursor compositions contain 1 to 40 weight percent, 5 to 40 weight percent, 10 to 40 weight percent, or 5 to 30 weight percent tackifier.

There is typically no solvent added to the second polymerizable reaction mixture. That is, the second polymerizable reaction mixture usually contains only the amount of organic solvent that may be present in the monomers as obtained from a commercial supplier. In some embodiments, the second polymerizable reaction mixture contains no or substantially no organic solvent. As used herein, the terms “substantially no” or “substantially free” with reference to the organic solvent means that the organic solvent is present in an amount less than 5 weight percent, less than 4 weight percent, less than 3 weight percent, less than 2 weight percent, or less than 1 weight percent based on the weight of polymerizable materials or polymerized materials.

The second precursor composition contains the second polymerizable reaction mixture and inorganic particles. The second polymerizable reaction mixture includes (a) a second crosslinker and (b) either (i) a second monovalent monomer mixture or (ii) a partially polymerized product of the second monovalent monomer mixture. Some exemplary second precursor compositions contain the second crosslinker in an amount in a range of 0.01 to 25 weight percent. The second monovalent monomer mixture often includes a) an alkyl(meth)acrylate in an amount in a range of 40 to 99 weight percent and b) a polar monomer in an amount in a range of 1 to 40 weight percent. The initiator is often present in an amount in the range of 0.01 to 5 weight percent. The inorganic particles are often present in an amount in the range of 1 to 25 weight percent. These weight percent values are all based on the total weight of polymerizable material in the second polymerizable reaction mixture.

In a more specific example of the second precursor composition, the second crosslinker is present in an amount in the range of 0.01 to 10 weight percent and the second monovalent monomer mixture includes an alkyl(meth)acrylate in an amount in the range of 60 to 95 weight percent and a polar monomer is present in an amount in the range of 1 to 30 weight percent. The initiator is present in an amount in the range of 0.01 to 2 weight percent. The inorganic particles are present in an amount in the range of 5 to 20 weight percent. These weight percent values are all based on the total weight of polymerizable material in the second polymerizable reaction mixture.

The second precursor composition is often disposed on a support or another layer and then polymerized to form a pressure sensitive adhesive layer. Any method of disposing the second precursor composition on the support such as a release liner or other layer such as a backing layer can be used. For example, the second precursor composition can be applied as a coating layer on the support or other layer using a technique such as knife coating, die coating, or extrusion. The coating layer (i.e., second precursor layer) containing the second precursor composition then can be exposed to actinic radiation if a photoinitator is present or to heat if a thermal initiator is present. Exposure to actinic radiation or heat results in the polymerization of any remaining polymerizable material (i.e., polymerization of non-reacted ethylenically unsaturated groups) within the second precursor composition.

In some embodiments, prior to disposition of the second precursor composition on a support (e.g., release liner) or another layer (e.g., backing layer), some of the monomers included in the second polymerizable reaction mixture are partially polymerized to increase the viscosity of the second polymerizable reaction mixture. The viscosity is often increased to that corresponding to a syrup-like material. Often, the monovalent monomers such as the alkyl(meth)acrylate monomer and the polar monomer are mixed with a portion of the free radical polymerization initiator. Depending on the type of initiator added, the mixture is exposed to actinic radiation or heat to partially polymerize the monovalent monomers. Then, the crosslinker and any remaining portion of the initiator are added to the partially polymerized product. The inorganic particles in the second precursor composition can be added either before or after partial polymerization of the monovalent monomers. The resulting second precursor composition can then be disposed as a coating layer (i.e., second precursor layer) on the support or other layer. The coating layer can then be exposed to actinic radiation if a photoinitator is present or to heat if a thermal initiator is present. Exposure to actinic radiation or heat results in the reaction of polymerizable material within the second precursor composition.

Suitable actinic radiation includes electromagnetic radiation in the infrared region, visible region, ultraviolet region, or a combination thereof. The photoinitiator is often activated by exposure to ultraviolet light. Any source of ultraviolet light known in the art can be used. Suitable ultraviolet light sources include, but are not limited to, mercury arcs, low-pressure mercury lamps, medium-pressure mercury lamps, high-pressure mercury lamps, plasma arcs, ultraviolet backlights, ultraviolet light emitting diodes, and ultraviolet light emitting lasers. Often, light sources having a lower light intensity are preferred.

The polymerization reactions used to form the pressure sensitive adhesive layer from the second precursor composition are often performed in an inert environment (e.g., nitrogen, helium, argon, carbon dioxide, or the like) or in an environment free or substantially free of air or oxygen. For example, the precursor composition can be purged of air and oxygen using an inert gas. Alternatively, the polymerization and crosslinking reactions can be performed while the precursor composition is positioned between two surfaces such as between the backing layer and a release liner or between two release liners. The two other surfaces function to minimize exposure to air or oxygen during the polymerization reactions.

In some embodiments, it may be desirable to impart a microstructured surface to the outer surface of a pressure sensitive adhesive layer (i.e., the surface of the pressure sensitive adhesive layer opposite the backing layer). Microstructured surfaces tend to facilitate air egress during lamination to the substrate. If it is desired to have a microstructured surface on the pressure sensitive adhesive layer, this layer can be formed while in contact with a tool or a liner (e.g., a release liner) containing microstructured features. After curing the precursor composition to form the pressure sensitive adhesive layer, the liner or tool can then be removed to expose an adhesive layer having a microstructured surface. With optical applications, it is generally desirable that the microstructures disappear over time to prevent interference with the optical performance or properties.

Any suitable thickness can be used for the pressure-sensitive adhesive layer or layers. In many embodiments, each pressure-sensitive adhesive layer has a thickness no greater than 20 mils (500 micrometers), no greater than 10 mils (250 micrometers), no greater than 5 mils (125 micrometers), no greater than 4 mils (100 micrometers), no greater than 3 mils (75 micrometers), or no greater than 2 mils (50 micrometers). The thickness of the pressure-sensitive adhesive layer is often at least 0.5 mils (12.5 micrometers) or at least 1 mil (25 micrometers). For example, the thickness of the pressure-sensitive adhesive layer can be in the range of 0.5 mils (2.5 micrometers) to 10 mils (250 micrometers), in the range of 0.5 mils (5 micrometers) to 10 mils (250 micrometers), in the range of 0.5 mils (12.5 micrometers) to 5 mils (125 micrometers), in the range of 1 mil (25 micrometers) to 3 mils (75 micrometers), or in the range of 1 mil (25 micrometers) to 2 mils (50 micrometers).

In many embodiments, the adhesive tape is a dual sided adhesive tape. The backing layer often directly contacts the first and second pressure sensitive adhesive layers. Alternatively, the backing layer can be separated from the pressure sensitive adhesive layers with another layer such as a primer layer. As prepared, the adhesive tape often has a first release liner adjacent to the first pressure sensitive adhesive layer and a second release liner adjacent to the second pressure sensitive adhesive layer. To use the adhesive tape, each release liner can be removed to expose the pressure adhesive layer for adhering to another surface such as a substrate.

The copolymers used to prepare the adhesive tape are often selected so that the Young's modulus of each pressure sensitive adhesive layer is less than that of the backing layer. If the Young's modulus of the adhesive layer is less than that of the backing layer, the adhesive layer will yield during the deformation of the backing layer when stretched and the backing layer is less likely to tear. Additionally, the adhesive layer is often selected to have a higher percent elongation at break than the backing layer. If this condition is met, the pressure adhesive layer is less likely to leave residue on the substrates upon being released from the substrates.

The adhesive tape can be stretched (elongated) in a first direction (e.g., a lengthwise direction) at least 50 percent without breaking. In some embodiments, the adhesive can be stretched at least 100 percent, at least 150 percent, at least 200 percent, at least 300 percent, at least 400 percent, or at least 500 percent without breaking. The backing layer can often be stretched up to 1200 percent, up to 1000 percent, up to 800 percent, up to 750 percent, or up to 700 percent without breaking. These relatively large elongation values facilitate stretch releasing of the adhesive tape after being adhered to a substrate.

The adhesive tape, which contains a backing layer and at least one pressure sensitive adhesive layer, can be formed in any suitable manner. In many embodiments, the backing layer is prepared separately from the pressure sensitive adhesive layer. After preparation of the backing layer, at least one separately formed pressure sensitive adhesive layer can be laminated to a major surface of the backing layer. Often a first pressure sensitive adhesive layer is laminated to a first major surface of the backing layer and a second pressure sensitive adhesive layer is laminated to a second major surface (i.e., opposite the first major surface) of the backing layer.

More specifically, the adhesive tape can be prepared by providing a poly(alkylene) copolymer that is a first polymerized product of a first polymerizable mixture containing (1) a first alkene selected from ethene, propene, or a mixture thereof and (2) a second alkene selected from a 1,2-alkene having 4 to 8 carbon atoms. The method of making the adhesive tape further includes casting a backing layer containing the poly(alkylene) copolymer between a first support layer and a second support layer such that the backing layer has a haze no greater than 5 percent and a luminous transmission that is at least 90 percent based on ASTM D1003-07. The method still further includes positioning at least one pressure sensitive adhesive layer adjacent to a first major surface of the backing layer. The at least one pressure sensitive adhesive layer contains an acrylic copolymer that is crosslinked and inorganic particles dispersed or suspended in the acrylic copolymer in an amount up to 25 weight percent based on the weight of the acrylic copolymer.

In other embodiments, the backing layer is formed and then the second precursor composition is applied to at least one surface of the previously prepared backing layer. That is, the backing layer functions as the support for the deposition of the second precursor composition. The second precursor composition is polymerized to form a first pressure sensitive adhesive layer while in contact with the backing layer. If the adhesive tape has two pressure sensitive adhesive layers, the second pressure sensitive adhesive layer can be positioned adjacent to the other major surface (i.e., second major surface) of the backing layer by lamination of a separately formed pressure sensitive adhesive layer. Alternatively, another second precursor composition can be applied to the other major surface of the backing layer and polymerized to form the second pressure sensitive layer while in contact with the backing layer. In this alternative embodiment, the first pressure sensitive adhesive layer is often positioned adjacent to a first release liner.

In another example of making an adhesive tape with two adhesive layers, the backing layer can be cast between two adhesive layers that are disposed on release liners. That is, the first pressure sensitive adhesive layer can be prepared on a first release liner, a second pressure sensitive adhesive layer can be prepared on a second release liner, and the poly(alkylene) copolymer can be cast between the two adhesive layers. The hot poly(alkylene) copolymer extrudate can laminate to the first adhesive layer and to the second adhesive layer. No blocking agent or slip agent is needed. The resulting construction can have the following layers: first release liner-first adhesive layer-backing layer-second adhesive layer-second release liner.

In yet other methods, the backing layer and second precursor composition (one or two depending on whether one or two adhesive layers are desired) can be extruded between two liners. After extrusion, the at least one second precursor composition can be cured to form the pressure sensitive adhesive layer. Alternatively, the release liners can also be co-extruded. In most of these methods involving the use of two release liners, additives such as anti-blocking agents and slip agents are not needed. Any other method that can be envisioned to provide or maintain the optical clarity also can be used.

In another aspect, an article is provided. In a first embodiment, the article includes a first substrate and an adhesive tape that is adhered to the first substrate. The adhesive tape includes (A) a backing layer, (B) a first pressure sensitive adhesive layer that is adjacent to a first major surface of the backing layer, and (C) a tab that extends beyond the first substrate. Pulling the tab stretches the adhesive tape and releases the adhesive tape from the first substrate. The adhesive tape is stretchable at least 50 percent in a first direction without breaking when the tab is pulled. The adhesive tape is the same as described above.

In a second embodiment, the article includes a first substrate, a second substrate, and an adhesive tape positioned between the first substrate and the second substrate. The adhesive tape couples the first substrate to the second substrate. The adhesive tape includes a (A) a backing layer, (B) a first pressure sensitive adhesive layer that is adjacent to a first major surface of the backing layer and a second pressure sensitive adhesive layer that is adjacent to a second major surface of the backing layer, and (C) a tab that extends beyond at least one of the first substrate and the second substrate, wherein the tab is part of the backing layer or attached to the backing layer. Pulling the tab stretches the adhesive tape and releases the adhesive tape from the first substrate, from the second substrate, or from both the first substrate and the second substrate. The adhesive tape is stretchable at least 50 percent in a first direction without breaking when the tab is pulled. The adhesive tape is the same as described above.

The coupling step of two substrates with the adhesive tape can include providing the adhesive tape in a form that includes release liners adjacent to each adhesive layer. That is, the adhesive tape can be provided as a construction of layers arranged in the following order: first release liner-first adhesive layer-backing layer-second adhesive layer-second release liner. The first release liner can be removed to expose the first adhesive layer. The exposed first adhesive layer can then be positioned adjacent to the first substrate and adhered directly or indirectly to the first substrate. The second release liner can then be removed to expose the second adhesive layer. The exposed second adhesive layer can then be positioned adjacent to the second substrate and adhered directly or indirectly to the second substrate. Often different release liners are used such that one is removed more readily than the other.

Any suitable substrates can be adhered to each pressure sensitive adhesive layer. The substrates can provide any desired function, can be formed from any suitable material, and can have any desired flexibility, size, shape, thickness, or aspect ratio. The substrate can be a single layer or can include multiple layers of material such as a support layer, a primer layer, a hard coat layer (e.g., acrylic or polyurethane), a decorative design, or the like. Either substrate or both substrates can be an outer surface layer of another article. Either substrate or both substrates can contain any suitable material such as a polymeric material, glass material, ceramic material, metal-containing material (e.g., metal or metal oxide or metal alloy), or a combination thereof.

Exemplary metal, metal oxide, or metal alloy for use in a substrate can contain indium tin oxide, titanium, nickel, steel, aluminum, copper, zinc, iron, cobalt, silver, gold, platinum, lead, and the like. Exemplary polymeric materials for use in the substrate include polycarbonates, polyesters (e.g., polyethylene terephthalates and polyethylene naphthalates), polyurethanes, poly(meth)acrylates (e.g., polymethyl methacrylates), polyvinyl alcohols, polyvinyl chloride, polyolefins such as polyethylenes, polypropylenes, or poly(cyclic olefins) such as polynorbornene, polyvinyl chlorides, polyimides, cellulose triacetates, acrylonitrile-butadiene-styrene copolymers, epoxies, nylons, and the like.

In some embodiments of the article, the adhesive tape is adhered to a substrate that is conductive. For example, the substrate can have conductive traces that contain a conductive material such as a conductive polymer or a conductive metal-containing species. For example, the substrate can have conductive traces of indium-tin oxide. In these embodiments, the polar monomer included in the pressure-sensitive adhesive layer is often selected to have a hydroxyl group, secondary amido group, or tertiary amido group. That is, the polar monomer typically does not have an acidic group. Suitable polar monomers include, but are not limited to, hydroxy alkyl acrylates, N-alkyl acrylamide, N,N-dialkyl acrylamide, N-vinyl caprolactam, N-vinyl pyrrolidone, or N-vinyl imidazole.

In some embodiments of the article, an optically clear adhesive tape can be positioned between a first substrate and a second substrate such that the second substrate can be seen by viewing through both the first substrate and the second substrate. The second substrate preferably can be viewed without distortion through both the first substrate and the stretch releasable adhesive tape. In these embodiments, the adhesive tape is often optically clear. The second substrate and the first substrate can be, for example, optically coupled. As used herein, the term “optically coupled” means that the any air gap between the first substrate and the second substrate has been eliminated. An air gap can lead to mismatching of refractive indexes between substrates. The optical coupling of the substrates often leads to enhanced brightness and enhanced contrast. Further, the coupling of the substrates can provide increased structural support.

At least one of the substrates used in combination with an optically clear stretch releasable adhesive tape is often selected to be optically clear or transparent. The substrate can have a variety of functions such as, for example, providing flexibility, rigidity, strength or support, conductivity or insulation, reflectivity, antireflectivity, polarization, or transmissivity (e.g., selective with respect to different wavelengths). That is, the substrate can be flexible or rigid; reflective or non-reflective; visibly clear, colored but transmissive, or opaque (e.g., not transmissive); and polarizing or non-polarizing. The resulting articles can be an optical element or can be used to prepare an optical element. As used herein, the term “optical element” refers to an article or component that has an optical effect or optical application. The optical element can be used, for example, in an electronic display, projection devices or applications, photonics devices or applications, or graphic devices or applications.

In some of these devices or applications, the first substrate and second substrate can be independently selected from an outer layer of a display (e.g, electronic display), polarizer, touch panel, lens, reflector, diffraction grating, mirror, projection prism, or multilayer optical film. Exemplary substrates include, but are not limited to, the outer layer of liquid crystal displays, electrowetting displays, plasma displays, cathode ray tubes, or touch sensors.

More particularly, an article is provided that includes a first substrate, a second substrate, and a stretch releasable adhesive tape positioned between the first substrate and the second substrate. The first substrate and second substrate are each independently selected from a display, polarizer, touch panel, lens, reflector, diffraction grating, mirror, projection prism, or multilayer optical film. The stretch releasable adhesive tape is optically clear and couples the first substrate to the second substrate. The second substrate is visible when viewed through both the first substrate and the adhesive tape. The stretch releasable adhesive tape includes (A) a backing layer that contains a poly(alkylene) copolymer, (B) a first pressure sensitive adhesive layer that is adjacent to a first major surface of the backing layer and a second pressure sensitive adhesive layer that is adjacent to a second major surface of the backing layer, wherein each pressure sensitive adhesive layer includes an acrylic copolymer and inorganic particles dispersed or suspended in the second acrylic compound, and (C) a tab that extends beyond at least one of the first substrate and the second substrate. The adhesive tape can be stretched at least 50 percent in a first direction without breaking. For example, the length of the adhesive tape can be increased at least 50 percent without breaking.

In some applications, the first substrate is a protective layer that is coupled to a second substrate that is part of an information display device. The protective layer can be a protective film, a layer of glass, a layer of polycarbonate, or the like. The protective layer can function, for example, as a cover lens for the information display device. Examples of information display devices include devices with a wide range of display area configurations including liquid crystal displays, plasma displays, front and rear projection displays, cathode ray tubes, and signage. Such display area configurations can be employed in a variety of portable and non-portable information display devices including personal digital assistants, cell phones, touch-sensitive screens, wrist watches, car navigation systems, global positioning systems, depth finders, calculators, electronic books, CD or DVD players, projection television screens, computer monitors, notebook computer displays, instrument gauges, instrument panel covers, or signage such as graphic displays. In some applications, the bonding of a rigid cover to the display screen with the elimination of any air gap between them can improve the quality of the displayed image.

In some specific applications, the optically clear, stretch releasable adhesive tape can couple an information display device and a cover lens prepared of glass or polycarbonate. That is, the article can have the following construction: cover lens-optically clear, stretch releasable adhesive tape-information display device. More specifically, the article can be arranged in the following order: cover lens-first optically clear adhesive layer-backing layer-second optically clear adhesive layer-information display device. The information display device can be viewed by looking through both the cover lens and the optically clear, stretch releasable adhesive tape. For example, the first substrate can be a cover lens and the second substrate can be a liquid crystal display. The outer surface of the liquid crystal display is often a polarizer. In other example, the first substrate can be a cover lens and the second substrate can be an electrowetting display with an outer surface that is predominately glass.

The optically clear adhesive tape can be used to couple together more than two substrates. That is, the articles can include more than two substrates and more than one optically clear adhesive tape. For example, the article could be arranged in the following order: first substrate-first optically clear, stretch releasable adhesive tape-second substrate-second optically clear, stretch releasable adhesive tape-third substrate. More specifically, the article would be arranged in the following order: first substrate-first optically clear adhesive layer-first backing layer-second optically clear adhesive layer-second substrate-third optically clear adhesive layer-second backing layer-fourth optically clear adhesive layer-third substrate. The third substrate can be viewed by looking through the first substrate, the first optically clear adhesive layer, the second substrate, and the second optically clear adhesive layer. For example, the first substrate can be a cover lens, the second substrate can be a touch panel, and the third substrate can be an information display device such as a liquid crystal display. Touch panels often have an outer surface of glass, polyester, or indium tin oxide.

Alternatively, the optically clear, stretch releasable adhesive tapes can be used to couple two substrates together and another optically clear adhesive can be used to join additional substrates. For example, the article could be arranged in the following order-first substrate-optically clear adhesive-second substrate-optically clear, stretch releasable adhesive tape-third substrate. As a specific example, the first substrate can be a cover lens, the second substrate can be a touch panel, and the third substrate can be an information display device such as a liquid crystal display. This embodiment uses the stretch releasable adhesive tape only to couple the information display device to the rest of the article. Less expensive components can be coupled using an adhesive that is not stretch releasable.

In other applications, at least one of the substrates is an optical film. Any suitable optical film can be used in the articles. As used herein, the term “optical film” refers to a film that can be used to produce an optical effect. The optical films are typically polymer-containing films that can be a single layer or multiple layers. Some optical films have alternating layers of polymeric material with different indexes of refraction. Other optical films have alternating polymeric layers and metal-containing layers. The optical films are flexible and can be of any suitable thickness. The optical films often are at least partially transmissive, reflective, antireflective, polarizing, optically clear, or diffusive with respect to some wavelengths of the electromagnetic spectrum (e.g., wavelengths in the visible ultraviolet, infrared, or radio frequency regions of the electromagnetic spectrum). Exemplary optical films include, but are not limited to, visible mirror films, color mirror films, solar reflective films, infrared reflective films, ultraviolet reflective films, reflective polarizer films such as a brightness enhancement films and dual brightness enhancement films, absorptive polarizer films, optically clear films, tinted films, and antireflective films. Exemplary optical films are further described in the following patents: U.S. Pat. Nos. 6,049,419 (Wheatley et al.), 5,882,774 (Jonza et al.), 6,049,419 (Wheatley et al.), RE 34,605 (Schrenk et al.), 5,579,162 (Bjornard et al.), and 5,360,659 (Arends et al.).

The articles that include the two substrates coupled with the stretch releasable adhesive tape can be durable. As used herein, the term “durable” means that the articles can be subjected to elevated temperature (e.g., at least 50° C., at least 60° C., at least 70° C., at least 80° C., or at least 85° C.) and humidity conditions (e.g., at least 70 percent relative humidity, at least 75 percent relative humidity, at least 80 percent relative humidity, at least 85 percent relative humidity, or at least 90 percent relative humidity) without delamination. The elevated temperature and relative humidity conditions can be maintained for at least 1 day, at least 2 days, at least 3 days, at least 4 days, at least 5 days, at least 6 days, or at least 7 days. For example, the articles can be subjected to conditions such as 60° C. and 90 percent relative humidity or 85° C. and 85 percent relative humidity for 1 week without delamination. In many embodiments where the adhesive tape is optically clear, the adhesive tape remains optically clear even after exposure to the elevated temperature and humidity conditions. For example, the haze can remain no greater than 5 and the luminous transmission can be at least 90 percent. Preferably no bubbles form in the article and no optical distortions result from being subjected to the elevated temperature and humidity conditions.

Stated differently, the pressure-sensitive adhesive layers that include a crosslinked acrylic copolymer with inorganic particles such as silica particles dispersed or suspended in the acrylic copolymer can typically be removed (debonded) leaving little or no residue. After removal of the adhesive layer, the substrate is free or substantially free of the adhesive. For example, the adhesive layer can be adhered to a glass substrate for extended periods such as at least 1 week or at least 4 weeks and then be removed such that the glass substrate is free (i.e., no adhesive residue) or substantially free (i.e., almost no adhesive residue) of the adhesive. In contrast, pressure-sensitive adhesive layers prepared from the acrylic copolymer in the absence of any inorganic particles such as silica particle often do not release cleanly after being adhered to a substrate such as glass. In many instances, the adhesive tape breaks upon attempted removal, the adhesive leaves substantial residue (e.g., cohesive split), or the substrate is damaged by the removal process due to adhesive build (i.e., increased adhesion) over time. In at least some embodiments, the adhesive layers containing inorganic particles dispersed or suspended in the acrylic copolymer display significantly higher static load shear properties comparative to comparable adhesive layers without the inorganic particles.

Additionally, the adhesive tapes or pressure-sensitive adhesive layers preferably do not become yellow when exposed to the elevated temperature and humidity conditions. That is, the adhesive tapes can have resistance of ultraviolet radiation for extended periods of time. Still further, the adhesive tapes can be used under conditions where there is exposure to moisture. The adhesives can often be used in both indoor and outdoor applications.

The dual sided adhesive tape can be adhered to two substrates (i.e., the adhesive tape can be positioned between the two substrates) and then released from one or both substrates by stretching the backing layer and the adhesive layers of the adhesive tape. After being released, adhesive tape can be removed from between the two substrates and the substrates can be separated from each other. The adhesive tape can be constructed so that the first pressure-sensitive adhesive layer can be released from the first substrate prior to completely releasing the second pressure-sensitive adhesive from the second substrate. That is, the adhesive tape can be constructed to provide controlled sequential release from the first substrate and from the second substrate. This can often be accomplished by variation in the composition of the acrylic copolymer included in the first pressure-sensitive adhesive and the second pressure-sensitive adhesive. Alternatively, this can be accomplished by having non-adhesive zones in one of the pressure-sensitive adhesive layers as described in U.S. Pat. No. 6,001,471 (Bries et al.).

The dual sided adhesive tape can be adhered to two substrates (i.e., the adhesive tape can be positioned between the two substrates) and then released from one or both substrates by stretching the backing layer and the adhesive layers of the adhesive tape. After being released, adhesive tape can be removed from between the two substrates and the substrates can be separated from each other. For example, the adhesive tape can be released by stretching in the event that the coupling of the two substrates is defective. Defects during fabrication can result from misalignment of the two substrates, entrapment of bubbles between the two substrates, or formation of patterns or creases. Alternatively, the substrates can be separated to allow at least one of the substrates to be used again. Typically, the stretch releasing adhesive tape can be cleanly removed from between the substrates with little or no visible adhesive residue remaining on either substrate. Additionally, the stretch releasing adhesive tape usually can be removed without damaging the appearance, function, or performance of either substrate. Even though the adhesive tape can be removed easily by stretching, the adhesive tape can provide high load shear adhesion prior to being stretched.

Also, over the lifetime of the device, if it is desirable to remove one of the substrates for replacement or recycling, the two substrates can be separated by stretch releasing the adhesive tape between the substrates. The substrates can be separated without damage to either substrate. This is an advantage over many other separation methods that typically introduce levels of stress than can damage one or both of the substrates. Such separation can be very difficult with many known pressure sensitive adhesives.

In some applications it may be desirable to use a winding tool to aid the stretch release process and facilitate removal of the adhesive tape from between the two substrates. Such a winding tool can be as simple as a cylinder to which the tab of the adhesive tape is attached. The winding tool can be rotated to permit winding of the adhesive tape as it is stretched. Such a process could be mechanized using a powered roller of sufficient width so that the entire width of the tab can be simultaneously and smoothly pulled to release the adhesive tape from the substrates by zero degree peel. The stress and the rate of strain applied to the adhesive tape by the mechanized device could be controlled to release and remove the adhesive tape without tearing the backing layer and without leaving any adhesive residue on the substrates. The mechanized approach would be particularly advantageous for the decoupling of large substrates such as large format electronic displays or graphics. Vacuum manipulation devices could be used to lift and support the substrates during the decoupling step. By securing the substrates with vacuum manipulation tools, the substrates could be secured without introducing additional compressive force on the adhesive tape that could inhibit or prevent the release and removal of the adhesive tape from between the two substrates. Also, the vacuum manipulation tools could be used to collect the substrates without damage after removal of the adhesive tape.

### EXAMPLES

These examples are for illustrative purposes only and are not meant to be limiting on the scope of the appended claims. All parts, percentages, and ratios in the examples and the rest of the specification are based on weight, unless noted otherwise. Solvents and other reagents used were obtained from Sigma-Aldrich Chemical Company (Milwaukee, Wis.) unless otherwise noted.

### Materials

2HEA refers to 2-hydroxy ethyl acrylate, which is available from Dow Chemical Co., (Freeport, Tex.).

2EHA refers to 2-ethyl hexyl acrylate, which is available from Sartomer (Exton, Pa.)

t-OACM refers to tert-octyl acrylamide, which is available from National Starch and Chemical Co. (Bridgewater, Fla.).

TPGDA refers to tripropylene glycol diacrylate, which is available from Sartomer (Exton, Pa.).

IBOA refers to isobornyl acrylate, which is available from Sartomer (Exton, Pa.).

IOA refers to isooctyl acrylate, which is available from Sartomer (Exton, Pa.)

AA refers to acrylic acid, which is available from BASF Corporation (Parsippany, N.J.).

NVC refers to N-vinyl caprolactam, which is available from Sigma-Aldrich Co. (Milwaukee, Wis.).

IRGACURE 651 is the trade designation of 2,2-dimethoxy-1,2-diphenylethane-1-one, which is commercially available from Ciba-Geigy (Hawthorne, N.Y.).

HDDA refers to 1,6-hexanediol diacrylate, which is available from Sigma-Aldrich Co. (Milwaukee, Wis.).

AEROSIL R972 and AEROSIL R812 are trade designations for hydrophobic fumed silica commercially available from Evonik (Essen, Germany).

AEROSIL 8200, AEROSIL R300, AEROSIL 130, and AEROSIL R380 are trade designations for hydrophilic fumed silica commercially available from Evonik (Essen, Germany).

NANOGEL is a trade designation for silica aerogel powder, grade OBD201 (about 8 micron average particle size) that is commercially available from Cabot Corp. (Billerica, Mass.).

EXACT 3040 is a trade designation for an ethylene-hexene copolymer with a melt index of 16.5 grams/10 minutes and a density of 0.900 grams per cubic centimeter that is available from ExxonMobil (Houston, Tex.).

EXACT 4011 is a trade designation for an ethylene-butene copolymer with a melt index of 2.2 grams/10 minutes and a density of 0.888 grams per cubic centimeter that is available from ExxonMobil (Houston, Tex.).

EXACT 5181 is a trade designation for an ethylene-octene copolymer with a melt index of 1.1 grams/10 minutes and a density of 0.87 grams per cubic centimeter that is available from ExxonMobil (Houston, Tex.).

EXACT 8210 is a trade designation for an ethylene-octene copolymer with a melt index of 10 grams/10 minutes and a density of 0.882 grams per cubic centimeter that is available from ExxonMobil (Houston, Tex.).

INFUSE D9000.05 is a trade designation for an ethylene-alpha olefin block copolymer with a melt index of 0.5 grams/10 minutes and a density of 0.877 grams per cubic centimeter that is available from Dow Chemical Co. (Freeport, Tex.).

VISTAMAXX 6102 is a trade designation for an propylene-ethylene-alpha olefin copolymer with a melt index of 3.0 grams/10 minutes and a density of 0.862 grams per cubic centimeter that is available from ExxonMobil (Houston, Tex.).

PET refers to a polyethylene terephthalate film that is 2 mils (1 mil is equal to 0.001 inch) thick and that is commercially available under the trade designation SCOTCHPAR from 3M (St. Paul, Minn.).

### Test Methods

### Stretch Release Stress Measurement

A double-coated adhesive tape strip (1.25 cm by 2.5 cm) was placed between two glass microscope slides (7.6 cm by 3.80 cm) leaving a 25 mm tab protruding from one end of the assembly. The assembly was pressed twice with a 4.5 kg roller to firmly bond the sample to the slides. The assembly was mounted in a tensile testing machine (INSTRON Model 4501 from Instron Co., Canton, Mass.) so that the glass slides were gripped in the lower (fixed) jaws, and the tab is clamped in the upper (crosshead) jaws. The jaws were separated at a rate of 30.5 cm/min, and the average force required to effect debonding by stretching (called debond stress in N/cm2) was recorded. The results were characterized by either a “Yes” indicating that the adhesive tape was cleanly removed from between the two substrate or a “No”-indicating that the substantial residue was left on the substrate.

### Haze and Luminous Transmission

Haze and Transmission was determined using a Gardner BYK Color TCS Plus model 8870 spectrophotometer from BYK Gardner, (Columbia, Md.) as described in ASTM Method 1003-07. CIE Standard Illuminant A was used. Percent haze and percent luminous transmittance were recorded.

### Preparation of Backing Layers:

Backing layers were prepared in a 0.75 inch BRABENDER laboratory extruder Model D-5 with a mixing screw that is commercially available from C.W. Brabender Instruments Inc. (So. Hackensack, N.J.). After melting and mixing backing resin, the extrudate was forced through a 6 inch flat cast extrusion die to form a film. The temperatures within the extruder were 160° C. (zone 1), 180° C. (zone 2), 190° C. (zone 3), 190° C. (adapter), and 190° C. (die) respectively. The extruded film was then cast between two PET films. The resulting laminate (PET/extrudate film/PET) was passed through a chilled roll stack to cool and solidify the resin copolymer. The line speed was adjusted to produce a solidified film with the desired caliper. Backing layers were pretreated prior to lamination to the PSA layer using an air corona treatment device Model BD-20 (Electronic Products, Inc., Chicago, Ill.). Each face of the film was exposed to the corona treatment at a rate of 0.5 square feet per minute immediately prior to lamination of the PSA layer.

### Examples 1 to 26

A syrup was prepared from an initial mixture of monomers as specified in Table 1 and 2,2-dimethoxy-2-phenyl acetophenone initiator (0.04 phr). As used herein, the abbreviation “phr” refers to parts per 100 parts. More specifically, the initial mixture for Example 1 included 90 parts IOA, 10 parts AA, and 4 parts initiator. This initial mixture was partially polymerized by ultraviolet radiation under nitrogen atmosphere until the Brookfield viscosity was between 1000 and 3000 centipoises. Following partial polymerization, the specified multifunctional monomer (see Table 1) and additional 2,2-dimethoxy-2-phenyl acetophenone initiator (0.2 phr) were added to the syrup. Inorganic particles were homogeneously dispersed into the syrup using an OMNIMIXER high shear mixer (Model 17105, OCI Instruments Inc., Waterbury, Conn.) or a SPEED MIXER DAC-150FV (Flack Tek, Inc., Landrum, S.C.).

A layer of the syrup was coated between two silicone-treated PET release liners at a thickness of 38 microns using a knife coater. The first silicone-treated PET release liner was CLEARSIL T10 from CP Films (St. Louis, Mo.) and the second silicone-treated PET release liner was CLEARSIL T50 from CP Films. The coated sample was cured under an ultraviolet light assembly containing two GE black light bulbs for a period of 8 minutes for a total dose of 880 mJ/cm² to prepare the pressure sensitive adhesive layer (PSA layer). Adhesive tapes were prepared by laminating the PSA layer on to the backing layer, which is identified in Table 1 for each example. The lamination was carried out at room temperature by removing one silicone-treated PET release liner from the PSA layer, contacting the exposed PSA layer surface to the backing layer, and rolling the adhesive down onto the backing layer using a 4.5 pound rubber covered roller. This procedure was repeated for the opposite side of the backing layer to produce the tape. The resulting adhesive tapes are described in Table 1. Various properties of the adhesive tapes are shown in Table 2.

TABLE 1
Examples 1 to 26 Description

| Example | Monovalent | Crosslinker | Inorganic | Backing Layer |
|---|---|---|---|---|
| No. | monomers | (phr) | Particles (phr) | (mils) |
| 1 | IOA/AA | HDDA | NANOGEL | EXACT 8210 |
| | (90/10) | (0.2) | OBD201 (5) | (4) |
| 2 | IOA/NVC | TPGDA | AEROSIL | EXACT 3040 |
| | (95/5) | (0.3) | R972 (15) | (4) |
| 3 | IOA/NVC | TPGDA | AEROSIL | EXACT 8210 |
| | (95/5) | (0.3) | R972 (15) | (4) |
| 4 | 2EHA/NVC | TPGDA | AEROSIL | EXACT 8210 |
| | (95/5) | (0.2) | R972 (15) | (4) |
| 5 | 2EHA/NVC | TPGDA | AEROSIL | EXACT 8210 |
| | (95/5) | (0.4) | R972 (15) | (4) |
| 6 | IOA/2HEA | TPGDA | AEROSIL | EXACT 8210 |
| | (90/10) | (0.2) | R972 (15) | (4) |
| 7 | IOA/2HEA | TPGDA | AEROSIL | EXACT 8210 |
| | (90/10) | (0.2) | R972 (5) | (4) |
| 8 | IOA/OACM | TPGDA | AEROSIL | EXACT 5181 |
| | (90/10) | (0.2) | R972 (10) | (4) |
| 9 | IOA/OACM | TPGDA | AEROSIL | EXACT 8210 |
| | (90/10) | (0.2) | R972 (5) | (4) |
| 10 | IOA/IBOA/OACM | TPGDA | AEROSIL | EXACT 8210 |
| | (85/10/5) | (0.2) | R972 (10) | (4) |
| 11 | IOA/IBOA/OACM | TPGDA | AEROSIL | EXACT 8210 |
| | (85/10/5) | (0.2) | R972 (5) | (4) |
| 12 | IOA/IBOA/2HEA | TPGDA | AEROSIL | EXACT 8210 |
| | (75/15/10) | (0.2) | R972 (15) | (4) |
| 13 | IOA/IBOA/2HEA | HDDA | AEROSIL | EXACT 5181 |
| | (75/15/10) | (0.3) | R812 (5) | (4) |
| 14 | IOA/IBOA/2HEA | TPGDA | AEROSIL | INFUSE |
| | (75/15/10) | (0.2) | R972 (5) | D9000.05 (4) |
| 15 | IOA/IBOA/2HEA | TPGDA | AEROSIL | EXACT 3040 |
| | (75/15/10) | (0.2) | R972 (5) | (4) |
| 16 | IOA/IBOA/2HEA | TPGDA | AEROSIL | EXACT 4011 |
| | (75/15/10) | (0.2) | R972 (5) | (4) |
| 17 | IOA/IBOA/2HEA | TPGDA | AEROSIL | VISTAMAXX |
| | (75/15/10) | (0.2) | R972 (5) | 6102 (6) |
| 18 | IOA/NVC | TPGDA | AEROSIL | EXACT 3040 |
| | (95/5) | (0.3) | R972 (15) | (4) |
| 19 | IOA/NVC | TPGDA | AEROSIL | EXACT 5181 |
| | (95/5) | (0.3) | R972 (15) | (2) |
| 20 | IOA/NVC | TPGDA | AEROSIL | EXACT 5181 |
| | (95/5) | (0.3) | R972 (15) | (3) |
| 21 | IOA/NVC | TPGDA | AEROSIL | EXACT 5181 |
| | (95/5) | (0.3) | R972 (15) | (4) |
| 22 | IOA/NVC | TPGDA | AEROSIL | EXACT 5181 |
| | (95/5) | (0.3) | R972 (15) | (5) |
| 23 | IOA/NVC | TPGDA | AEROSIL | EXACT 5181 |
| | (95/5) | (0.3) | R972 (15) | (6) |
| 24 | IOA/NVC | TPGDA | AEROSIL | EXACT 5181 |
| | (95/5) | (0.3) | R972 (15) | (7) |
| 25 | IOA/NVC | TPGDA | AEROSIL | EXACT 5181 |
| | (95/5) | (0.3) | R972 (15) | (9) |
| 26 | IOA/NVC | TPGDA | AEROSIL | EXACT 8210 |
| | (95/5) | (0.3) | R972 (15) | (4) |

TABLE 2
Properties of Examples 1 to 26

| | | Luminous | Debond | |
|---|---|---|---|---|
| Example | | Transmission | Stress | Clean |
| No. | Haze (%) | (%) | (psi) | Removal |
| 1 | Not tested | Not tested | 323 | Yes |
| 2 | 0.4 | 92.2 | 899 | Yes |
| 3 | 0.7 | 92.5 | 657 | Yes |
| 4 | 1.6 | 92.5 | 694 | Yes |
| 5 | Not tested | Not tested | 668 | Yes |
| 6 | 1.3 | 92.7 | 265 | Yes |
| 7 | 1.1 | 92.6 | 250 | Yes |
| 8 | 2 | 91.9 | 572 | Yes |
| 9 | 0.9 | 92.9 | 251 | Yes |
| 10 | 1 | 91.8 | 275 | Yes |
| 11 | 0.8 | 92 | 263 | Yes |
| 12 | 1.2 | 92.5 | 260 | Yes |
| 13 | 0.8 | 92 | 385 | Yes |
| 14 | 2.9 | 91.1 | 403 | Yes |
| 15 | 1.3 | 92.2 | 740 | Yes |
| 16 | 1.1 | 92.5 | 551 | Yes |
| 17 | Not tested | Not tested | 408 | Yes |
| 18 | 0.4 | 92.21 | 899 | Yes |
| 19 | 0.3 | 92.4 | 697 | Yes |
| 20 | 0.2 | 92.7 | 673 | Yes |
| 21 | 0.8 | 92.6 | 622 | Yes |
| 22 | 0.1 | 92.4 | 648 | Yes |
| 23 | Not tested | Not tested | 551 | Yes |
| 24 | 0.2 | 92.3 | 680 | Yes |
| 25 | 0.2 | 92 | 696 | Yes |
| 26 | 0.7 | 92.5 | 628 | Yes |

### Examples 27 to 36

The pressure sensitive adhesive syrup was prepared as described for Examples 1 to 26. The mixture of syrup and inorganic particles was coated with a 1.5 mil gap between the first side of a backing layer (4 mils) and a silicone-treated PET release liner (CLEARSIL T10, CP Films, St. Louis, Mo.) at a thickness of 38 microns using a knife coater. The coated sample was cured under an ultraviolet light assembly containing two GE black light bulbs for a total dose of 500 mJ/cm².

A second coat of similar thickness was applied to the second side of the backing layer and was covered with a silicone liner (CLEARSIL T50, CP Films, St. Louis, Mo.). The coated sample was cured under an ultraviolet light assembly containing two GE black light bulbs for a total dose of 880 mJ/cm².

The examples are described in Table 3. Various properties of the adhesive tapes are shown in Table 4.

TABLE 3
Examples 27 to 36 Description

| | | | Inorganic | |
|---|---|---|---|---|
| Example | Monovalent | Crosslinker | Particles | Backing |
| No. | monomers | (phr) | (phr) | Layer |
| 27 | IOA/IBOA/2HEA | TPGDA (0.2) | AEROSIL | EXACT |
| | (75/15/10) | | R972 (5) | 8210 |
| 28 | IOA/IBOA/2HEA | HDDA (0.3) | AEROSIL | EXACT |
| | (75/15/10) | | 8200 (5) | 5181 |
| 29 | IOA/IBOA/2HEA | HDDA (0.3) | AEROSIL | EXACT |
| | (75/15/10) | | R300 (5) | 5181 |
| 30 | IOA/IBOA/2HEA | HDDA (0.3) | AEROSIL | EXACT |
| | (75/15/10) | | R380 (5) | 5181 |
| 31 | IOA/IBOA/2HEA | TPGDA (0.2) | AEROSIL | EXACT |
| | (75/15/10) | | R972 (10) | 5181 |
| 32 | IOA/IBOA/2HEA/NVC | TPGDA (0.3) | AEROSIL | EXACT |
| | (75/10/10/5) | | R130 (10) | 5181 |
| 33 | IOA/IBOA/2HEA/NVC | TPGDA (0.3) | AEROSIL | EXACT |
| | (75/10/10/5) | | R380 (10) | 5181 |
| 34 | IOA/IBOA/2HEA/NVC | TPGDA (0.3) | AEROSIL | EXACT |
| | (75/10/10/5) | | R812 (10) | 5181 |
| 35 | IOA/IBOA/2HEA/NVC | TPGDA (0.3) | AEROSIL | EXACT |
| | (75/13/10/2) | | R130 (10) | 5181 |
| 36 | IOA/IBOA/2HEA/NVC | TPGDA (0.3) | AEROSIL | EXACT |
| | (75/13/10/2) | | R380 (10) | 5181 |

TABLE 4
Properties of Examples 27 to 36

| | | Luminous | Debond | |
|---|---|---|---|---|
| Example | Haze | Transmission | Stress | Clean |
| No. | (%) | (%) | (psi) | Removal |
| 27 | 1.1 | 92.5 | 285 | Yes |
| 28 | 1 | 92.1 | 387 | Yes |
| 29 | 1 | 92.5 | 451 | Yes |
| 30 | 1 | 92.2 | 322 | Yes |
| 31 | Not tested | Not tested | 424 | Yes |
| 32 | Not tested | Not tested | 1056 | Yes |
| 33 | Not tested | Not tested | 436 | Yes |
| 34 | Not tested | Not tested | 369 | Yes |
| 35 | Not tested | Not tested | 589 | Yes |
| 36 | Not tested | Not tested | 563 | Yes |

### Comparative Examples C1 to C6

Comparative examples were prepared similarly to Example 1 to 26 by laminating the PSA layer onto a backing layer. The lamination was carried out at room temperature by removing one silicone-treated PET release liner from the adhesive transfer tape, and rolling the adhesive down onto the backing layer (4 mils) using a 4.5 pound rubber covered roller. This procedure was repeated for the opposite side of the backing layer to produce the dual sided adhesive tape. These resulting adhesive tapes are described in Table 5. Certain properties of the adhesive tapes are included in Table 6.

TABLE 5
Comparative Examples 1 to 6 Description

| | | | Inorganic | |
|---|---|---|---|---|
| Comparative | Monovalent | Crosslinker | Particles | Backing |
| Example | monomers | (phr) | (phr) | Layer |
| C1 | IOA/2HEA | TPGDA (0.2) | none | EXACT |
| | (90/10) | | | 8210 |
| C2 | IOA/IBOA/2HEA | TPGDA (0.2) | none | EXACT |
| | (75/15/10) | | | 8210 |
| C3 | IOA/OACM | TPGDA (0.2) | none | EXACT |
| | (90/10) | | | 8210 |
| C4 | IOA/IBOA/OACM | TPGDA (0.2) | none | EXACT |
| | (85/10/5) | | | 8210 |
| C5 | IOA/2HEA | TPGDA (0.2) | none | EXACT |
| | (90/10) | | | 5181 |
| C6 | IOA/OACM | TPGDA (0.2) | none | EXACT |
| | (90/10) | | | 5181 |

TABLE 6
Properties of Comparative Examples C1 to C6

| | | Luminous | Debond | |
|---|---|---|---|---|
| Comparative | Haze | Transmission | Stress | Clean |
| Example | (%) | (%) | (psi) | Removal |
| C1 | 1.1 | 92.5 | 536 | No |
| C2 | 1.3 | 92.4 | 411 | No |
| C3 | 1 | 92.6 | 542 | No |
| C4 | 1.1 | 92.4 | 608 | No |
| C5 | 0.8 | 92.6 | 536 | No |
| C6 | 0.8 | 92.6 | 520 | No |

1. An adhesive tape comprising:
a backing layer comprising a poly(alkylene) copolymer comprising a polymerized product of a first polymerizable reaction mixture comprising
(1) a first alkene selected from ethene, propene, or a mixture thereof;
(2) a second alkene selected from a 1,2-alkene having 4 to 8 carbon atoms; and
(3) a metallocene catalyst; and
at least one pressure sensitive adhesive layer that is adjacent to a major surface of the backing layer, wherein the pressure sensitive adhesive layer comprises
(1) an acrylic copolymer comprising a crosslinked reaction product of a second polymerizable reaction mixture comprising
(a) a crosslinker having at least two (meth)acryloyl groups in an amount up to 25 weight percent based on a total weight of polymerizable material in the second polymerizable reaction mixture; and
(b) either
(i) a second monovalent monomer mixture comprising
1) an alkyl(meth)acrylate having an alkyl group with at least 4 carbon atoms in an amount equal to at least 40 weight percent based on the total weight of polymerizable material in the second polymerizable reaction mixture; and
2) a polar monomer in an amount up to 40 weight percent based on the total weight of polymerizable material in the second polymerizable reaction mixture; or
(ii) a partially polymerized product of the second monovalent monomer mixture; and
(2) inorganic particles dispersed or suspended in the acrylic copolymer in an amount up to 25 weight percent based on the total weight of acrylic copolymer,
wherein the adhesive tape is stretchable at least 50 percent in a first direction without breaking.

2. The adhesive tape of claim 1, wherein the adhesive tape is optically clear.

3. The adhesive tape of claim 1 or claim 2, wherein the poly(alkylene) copolymer has a specific gravity in the range of 0.86 to 0.91.

4. The adhesive tape of claim 1, wherein the inorganic particles comprise silica.

5. The adhesive tape of claim 1, wherein the inorganic particles comprise fumed silica or silica aerogel particles.

6. The adhesive tape of claim 1, wherein the adhesive tape is stretchable at 300 percent in the first direction without breaking.

7. The adhesive tape of claim 1, where the polar monomer in the second monovalent mixture is present in an amount in the range of 1 to 30 weight percent based on the total weight of polymerizable material in the second polymerizable reaction mixture.

8. The adhesive tape of claim 1, wherein the adhesive tape comprises the backing layer, a first pressure sensitive adhesive layer adjacent to a first major surface of the backing layer, and a second pressure sensitive adhesive layer adjacent to a second major surface of the backing layer.

9. The adhesive tape of claim 8, further comprising a first release liner adjacent to the first pressure sensitive adhesive layer opposite the backing layer and a second release liner adjacent to the second pressure sensitive adhesive layer opposite the backing layer.

10. An article comprising:
a first substrate;
a second substrate; and
an adhesive tape positioned between the first substrate and the second substrate, wherein the adhesive tape couples the first substrate to the second substrate, the adhesive tape comprising
(A) a backing layer comprising a poly(alkylene) copolymer comprising a polymerized product of a first polymerizable reaction mixture comprising
(1) a first alkene selected from ethene, propene, or a mixture thereof;
(2) a second alkene selected from a 1,2-alkene having 4 to 8 carbon atoms; and
(3) a metallocene catalyst;
(B) a first pressure sensitive adhesive layer that is adjacent to a first major surface of the backing layer and a second pressure sensitive adhesive layer that is adjacent to a second major surface of the backing layer, wherein the first pressure sensitive adhesive layer and the second pressure sensitive adhesive layer each comprise
(1) an acrylic copolymer comprising a crosslinked reaction product of a second polymerizable reaction mixture comprising
(a) a crosslinker having at least two (meth)acryloyl groups in an amount up to 25 weight percent based on a total weight of polymerizable material in the second polymerizable reaction mixture; and
(b) either
(i) a second monovalent monomer mixture comprising
1) an alkyl(meth)acrylate having an alkyl group with at least 4 carbon in an amount equal to at least 40 weight percent based on the total weight of polymerizable material in the second polymerizable reaction mixture; and
2) a polar monomer in an amount up to 40 weight percent based on the total weight of polymerizable material in the second polymerizable reaction mixture; or
(ii) a partially polymerized product of the second monovalent monomer mixture; and
(2) inorganic particles dispersed or suspended in the acrylic copolymer in an amount up to 25 weight percent based on the weight of the acrylic copolymer; and
(C) a tab that extends beyond at least one of the first substrate and the second substrate, wherein pulling the tab stretches the adhesive tape and releases the adhesive tape from the first substrate, from the second substrate, or from both the first substrate and the second substrate, wherein the adhesive tape is stretchable at least 50 percent in a first direction without breaking when the tab is pulled.

11. The article of claim 10, wherein adhesive tape is the first substrate and second substrate are each independently selected from a display, polarizer, touch panel, lens, reflector, diffraction grating, mirror, projection prism, or multilayer optical film.

12. The article of claim 10, wherein the second substrate is visible when viewed through the first substrate and the adhesive tape.

13. The article of claim 10, wherein the adhesive tape is stretchable at least 300 percent in the first direction without breaking.

14. The article of claim 10, wherein the first substrate or the second substrate comprises a conductive material.

15. The article of claim 14, wherein the conductive material comprises indium tin oxide.

16. An article comprising:
a first substrate; and
an adhesive tape adhered to the first substrate, the adhesive tape comprising
(A) a backing layer comprising a poly(alkylene) copolymer comprising a polymerized product of a first polymerizable reaction mixture comprising
(1) a first alkene selected from ethene, propene, or a mixture thereof;
(2) a second alkene selected from a 1,2-alkene having 4 to 8 carbon atoms; and
(3) a metallocene catalyst;
(B) a first pressure sensitive adhesive layer that is adjacent to a first major surface of the backing layer, wherein the first pressure sensitive adhesive layer comprises
(1) an acrylic copolymer comprising a crosslinked reaction product of a second polymerizable reaction mixture comprising
(a) a crosslinker having at least two (meth)acryloyl groups in an amount up to 25 weight percent based on a total weight of polymerizable material in the second polymerizable reaction mixture; and
(b) either
(i) a second monovalent monomer mixture comprising
1) an alkyl(meth)acrylate having an alkyl group with at least 4 carbon in an amount equal to at least 40 weight percent based on the total weight of polymerizable material in the second polymerizable reaction mixture; and
2) a polar monomer in an amount up to 40 weight percent based on the total weight of polymerizable material in the second polymerizable reaction mixture; or
(ii) a partially polymerized product of the second monovalent monomer mixture; and
(2) inorganic particles dispersed or suspended in the acrylic copolymer in an amount up to 25 weight percent based on the weight of the acrylic copolymer; and
(C) a tab that extends beyond the first substrate, wherein pulling the tab stretches the adhesive tape and releases the adhesive tape from the first substrate, wherein the adhesive tape is stretchable at least 50 percent in a first direction without breaking when the tab is pulled.

17. A method of coupling and decoupling two substrates, the method comprising:
providing a first and second substrate;
positioning an adhesive tape between the first substrate and the second substrate, wherein the adhesive tape couples the first substrate to the second substrate, the adhesive tape comprising
(A) a backing layer comprising a poly(alkylene) copolymer comprising a polymerized product of a first polymerizable reaction mixture comprising
(1) a first alkene selected from ethene, propene, or a mixture thereof;
(2) a second alkene selected from a 1,2-alkene having 4 to 8 carbon atoms; and
(3) a metallocene catalyst;
(B) a first pressure sensitive adhesive layer that is adjacent to a first major surface of the backing layer and a second pressure sensitive adhesive layer that is adjacent to a second major surface of the backing layer, wherein the first pressure sensitive adhesive layer and the second pressure sensitive adhesive layer each comprise
(1) an acrylic copolymer comprising a crosslinked reaction product of a second polymerizable reaction mixture comprising
(a) a crosslinker having at least two (meth)acryloyl groups in an amount up to 25 weight percent based on a total weight of polymeric material in the second polymerizable reaction mixture;
(b) either
(i) a second monovalent monomer mixture comprising
1) an alkyl(meth)acrylate having an alkyl group with at least 4 carbon in an amount equal to at least 40 weight percent based on the total weight of polymerizable material in the second polymerizable reaction mixture;
2) a second polar monomer in an amount up to 40 weight percent based on the total weight of polymerizable material in the second polymerizable reaction mixture; or
(ii) a partially polymerized product of the second monovalent monomer mixture; and
(2) inorganic particles dispersed or suspended in the acrylic copolymer in an amount up to 25 weight percent based on the weight of the acrylic copolymer; and
(C) a tab that extends beyond at least one of the first substrate and the second substrate; and
pulling on the tab of the adhesive tape to stretch the adhesive tape to release the adhesive tape from the first substrate, from the second substrate or from both the first substrate and the second substrate, wherein the adhesive tape is stretchable at least 50 percent in a first direction without breaking.

18. A method of making an adhesive tape, the method comprising:
providing a poly(alkylene) copolymer that is the polymerized product of a first polymerizable mixture comprising
(1) a first alkene selected from ethene, propene, or a mixture thereof;
(2) a second alkene selected from 1,2-alkene having 4 to 8 carbon atoms; and
(3) a metallocene catalyst;
casting a backing layer comprising the poly(alkylene) copolymer between a first support layer and a second support layer; and
positioning at least one pressure sensitive adhesive layer adjacent to a first major surface of the backing layer, wherein the at least one pressure sensitive adhesive layer comprises
(1) an acrylic copolymer comprising a polymerized product of a second polymerizable reaction mixture comprising
(a) a crosslinker having at least two (meth)acryloyl groups in an amount up to 25 weight percent based on a total weight of polymeric material in the second polymerizable reaction mixture;
(b) either
(i) a second monovalent monomer mixture comprising
1) an alkyl(meth)acrylate having an alkyl group with at least 4 carbon in an amount equal to at least 30 weight percent based on the total weight of polymerizable material in the second polymerizable reaction mixture;
2) a second polar monomer in an amount up to 60 weight percent based on the total weight of polymerizable material in the second polymerizable reaction mixture; or
(ii) a partially polymerized product of the second monovalent monomer mixture; and
(2) inorganic particles dispersed or suspended in the acrylic copolymer in an amount up to 25 weight percent based on the weight of the acrylic copolymer.
